(19) United States
(12) Patent Application Publication
(10) Pub. No.: US 2015/0249754 A1
(43) Pub. Date: Sep. 3, 2015

(54) IMAGE PROVIDING DEVICE AND IMAGE PROVIDING METHOD

(71) Applicant: FURYU CORPORATION, Tokyo (JP)

(72) Inventors: Kyoko TADA, Osaka (JP); Masanori SUMINAGA, Osaka (JP); Eiji SEO, Osaka (JP)

(21) Appl. No.: 14/632,416

(22) Filed: Feb. 26, 2015

(30) Foreign Application Priority Data
Feb. 28, 2014 (JP) 2014-039797

(51) Int. Cl. H04N 1/00; H04N 5/262; H04N 5/232

(52) U.S. Cl. CPC H04N 1/00167; H04N 5/23293; H04N 5/23229; H04N 5/2628; H04N 1/00244; H04N 1/00161; H04N 1/00172; H04N 1/00188

(57) ABSTRACT

A first display control section controls display of a selection screen to receive a selection of a layout image, a second display control section controls display of the selected layout image, and a shooting section shoots a user and generates one or more shot images. The layout image is an image in which the one or more shot images are arranged, the second display control section displays, in the layout image, one or more areas on which the one or more shot images are arranged, and the shooting section shoots the user in an image shooting range set to each of the one or more areas displayed in the layout image. The present technology can be applied to, for example, a photo sticker creating device.

### BACKGROUND

1. Technical Field

The present technology relates to an image providing device and an image providing method, more particularly, relates to an image providing device and an image providing method which can provide a user with an image as imagined by the user.

2. Related Art

Conventionally, a photo sticker machine installed in an amusement facility and the like is known. The photo sticker machine shoots a user and edits a shot image according to an operation of the user. The photo sticker machine prints the shot image which has been edited on a sticker sheet.

For example, JP 2003-72165 A discloses that a photo sticker machine enables a user to select a layout of a shot image to be printed on a sticker sheet before shooting, and to change the selected layout after shooting.

It is also known that a photo sticker machine edits not only a shot image but also an entire layout image, in which the shot image is arranged, to be printed on a sticker sheet.

Furthermore, JP 2011-53249 A discloses that a photo sticker machine displays a combination image generated by combining a plurality of shot images when shooting, with a live view image of an object. With the photo sticker machine, a user can perform shooting while imaging the combination image to be printed on a sticker sheet at the end.

### SUMMARY

However, with the photo sticker machine described in JP 2011-53249 A, the shot image is trimmed to be combined in a shape (such as a star shape or a heart shape) according to an arrangement of the combination image. Therefore, a size of an object in the shot image arranged in the combination image is different from that in the live view image when shooting. Consequently, the combination image printed on a sticker sheet is likely not to be the image as imagined by the user.

The present technology has been made in view of the foregoing, and can more reliably provide an image as imagined by a user.

An image providing device according to an aspect of the present technology includes: a first display control section configured to control display of a selection screen to receive a selection of a layout image; a second display control section configured to control display of the selected layout image; and a shooting section configured to shoot a user and generate one or more shot images, wherein the layout image is an image in which the one or more shot images are arranged, the second display control section displays, in the layout image, one or more areas on which the one or more shot images are arranged, and the shooting section shoots the user in an image shooting range set to each of the one or more areas displayed in the layout image.

When shooting, the second display control section can highlight one of the one or more areas on which one of the one or more shot images to be generated by the shooting section is to be arranged, and

the shooting section shoots the user in the image shooting range set to the highlighted area.

The second display control section can arrange and display the one of the one or more shot images generated by the shooting section on the highlighted area.

The shooting section can shoot the user in the image shooting range, in which a predetermined part of the body of the user is shot, set to each of the one or more areas displayed in the layout image.

The first display control section can categorize the layout image according to the image shooting range set to each of the one or more areas and displays the categorized layout images on the selection screen.

On one of the one or more areas of the layout image, a predetermined part of an image cut-out from the one or more shot images to be arranged on another one of the one or more areas is to be arranged.

The shooting section can shoot the user the number of times according to the number of the one or more shot images arranged in the layout image.

The second display control section can control display of the layout image each time the shooting section shoots the user, when the shooting is performed a plurality of times.

The image providing device further includes:

a third display control section configured to control display of an editing screen on which the layout image in which the one or more shot images are arranged is to be displayed; and

an editing section configured to edit, according to an input by the user, the one or more shot images arranged in the layout image displayed on the editing screen.

The editing section can change at least a color of the layout image according to an input by the user.

The image providing device further includes a printing section configured to print the layout image in which the one or more shot images are arranged on each of the one or more areas, divided into the number of divisions selected by the user, of the sticker sheet.

The image providing device further includes a transmission section configured to transmit the layout image, in which the one or more shot images are arranged, to a mobile terminal of the user through a predetermined server.

The first display control section can control display of the selection screen, when the number of the user is a predetermined number of persons.

An image providing method in an aspect of the present technology is an image providing method of an image providing device including:

a first display control section configured to control display of a selection screen to receive a selection of a layout image,

a second display control section configured to control display of the selected layout image, and

a shooting section configured to shoot a user and generate one or more shot images, the method including:

arranging the one or more shot images in the layout image;

displaying, in the layout image, one or more areas on which the one or more shot images are to be arranged by the second display control section; and

shooting the user in an image shooting range set to each of the one or more areas displayed in the layout image by the shooting section.

In an aspect of the present technology, in a layout image in which one or more shot images are to be arranged, one or more areas, on which the one or more shot images are to be arranged, are displayed and a user is shot in an image shooting range set to each of the one or more areas displayed in the layout image.

According to the present technology, it is possible to more reliably provide an image as imagined by a user.

### BRIEF DESCRIPTION OF DRAWINGS

FIG. 1 is a perspective view illustrating a configuration example of an appearance of a photo sticker creating device according to an embodiment of the present technology;

FIG. 2 is a perspective view of the appearance of the photo sticker creating device as viewed from another angle;

FIG. 3 is a diagram describing movements of a user;

FIG. 4 is a diagram illustrating a configuration example of a pre-service portion;

FIG. 5 is a diagram illustrating a configuration example of a shooting portion;

FIG. 6 is a diagram illustrating a configuration example of a background portion;

FIG. 7 is a diagram illustrating a configuration example of a front of an editing unit;

FIG. 8 is a diagram illustrating a configuration example of a side of the editing unit;

FIG. 9 is a block diagram illustrating an internal configuration example of the photo sticker creating device;

FIG. 10 is a block diagram illustrating a functional configuration example of a control section;

FIG. 11 is a block diagram illustrating a functional configuration example of a pre-service processing section;

FIG. 12 is a block diagram illustrating a functional configuration example of a shooting processing section;

FIG. 13 is a block diagram illustrating a functional configuration example of an editing processing section;

FIG. 14 is a flowchart describing photo sticker creation game processing;

FIG. 15 is a flowchart describing pre-service processing;

FIG. 16 is a diagram illustrating an example of a person-number course selection screen;

FIG. 17 is a diagram illustrating an example of a background selection screen;

FIG. 18 is a diagram illustrating an example of a sticker layout selection screen;

FIG. 19 is a flowchart describing shooting processing of a two-persons course or a three-or-more-persons course;

FIG. 20 is a diagram illustrating an example of a live view display screen when identification shooting is performed;

FIG. 21 is a diagram illustrating an example of a shooting result confirmation screen when the identification shooting is performed;

FIG. 22 is a diagram illustrating an example of a live view display screen;

FIG. 23 is a diagram illustrating an example of a shooting result confirmation screen;

FIG. 24 is a flowchart describing shooting processing of a one-person course;

FIG. 25 is a diagram illustrating an example of a live view display screen when the identification shooting is performed;

FIG. 26 is a diagram illustrating an example of a shooting result confirmation screen when the identification shooting is performed;

FIG. 27 is a diagram illustrating an example of a sticker layout image display screen;

FIG. 28 is a diagram illustrating an example of a live view display screen;

FIG. 29 is a diagram illustrating an example of a sticker layout image display screen after the shooting is performed;

FIG. 30 is a flowchart describing editing processing;

FIG. 31 is a diagram illustrating an example of an editing screen of the two-persons course or the three-or-more-persons course;

FIG. 32 is a diagram illustrating an example of an editing screen of the one-person course;

FIG. 33 is a diagram illustrating an example of an editing screen of the one-person course;

FIG. 34 is a diagram illustrating an example of a sticker layout image; and

FIG. 35 is a diagram illustrating an example of a sticker layout image.

### DETAILED DESCRIPTION

Hereinafter, specific embodiments to which the present technology is applied will be described in detail with reference to the drawings.

### <Configuration of Appearance of Photo Sticker Creating Device>

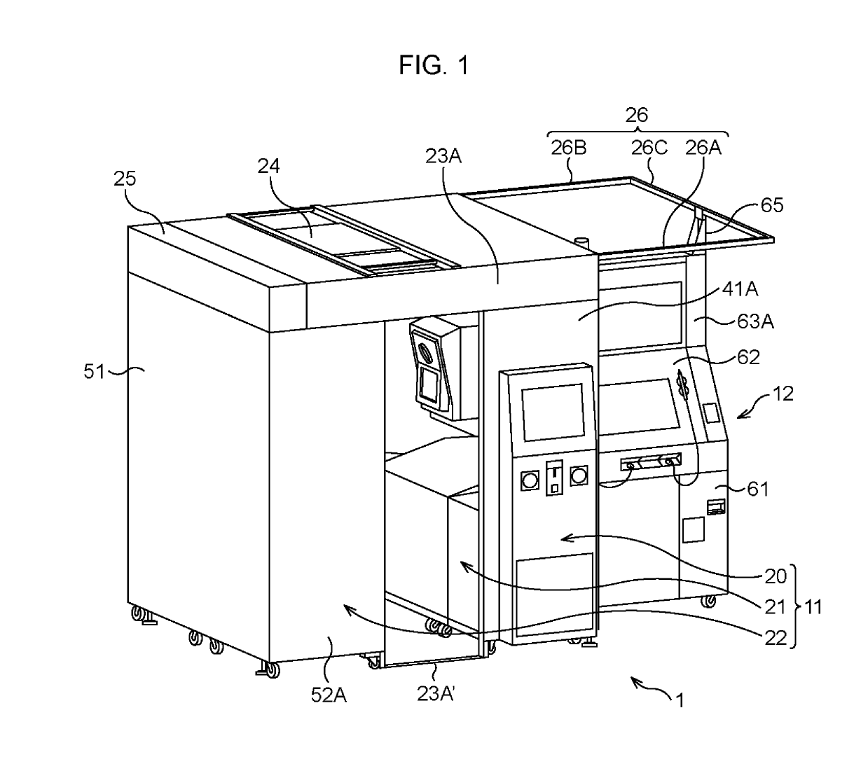

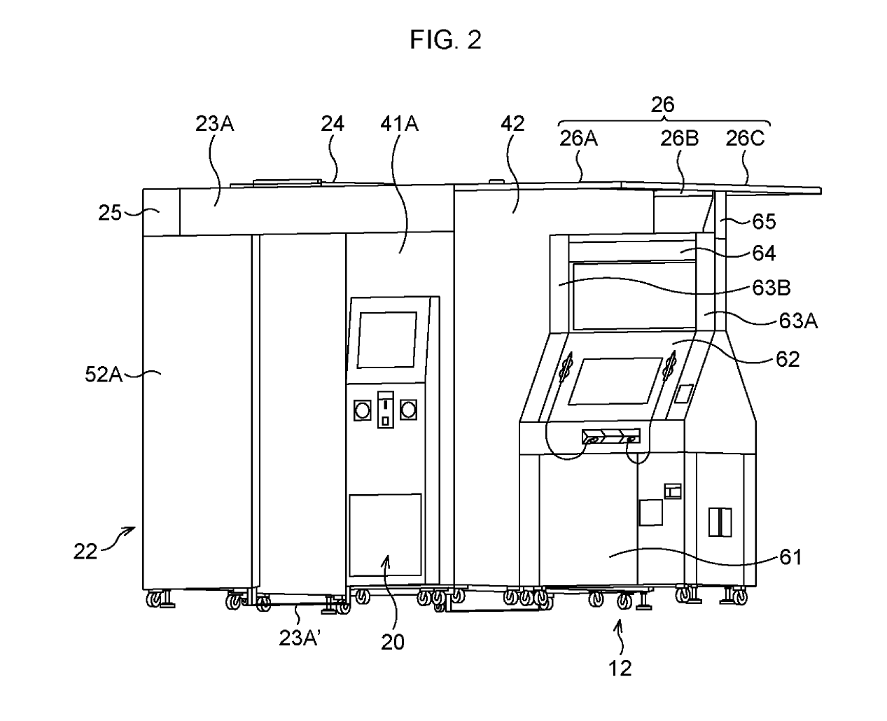

FIGS. 1 and 2 are perspective views illustrating a configuration example of an appearance of a photo sticker creating device 1.

The photo sticker creating device 1 is a game device which provides a shot image and an edited image. The photo sticker creating device 1 provides a user with the image by printing the image on a sticker sheet or transmitting the image to a server in order to browse the image on a mobile terminal of the user. The photo sticker creating device 1 is installed in an amusement facility, a shop, and the like. Users of the photo sticker creating device 1 are mainly high school girls and young women. A plurality of users, about two or three persons per a group, as well as a single user can enjoy a game of the photo sticker creating device 1.

In the photo sticker creating device 1, a user shoots oneself as an object. The user composites, by editing, an image for compositing, such as a handwritten character and a stamp image, on a selected image from the shot images obtained by the shooting. The shot image is thereby edited to be a colorful image. The user receives a sticker sheet on which the edited image, which has been edited, is printed and terminates a series of the game.

As illustrated in FIG. 1, the photo sticker creating device 1 is basically configured such that a shooting unit 11 and an editing unit 12 are installed in a contact state.

The shooting unit 11 is configured with a pre-service portion 20, a shooting portion 21, and a background portion 22. The pre-service portion 20 is installed on a side of the shooting portion 21. A front space of the pre-service portion 20 becomes a pre-service space where pre-service processing is performed. The shooting portion 21 and the background portion 22 are installed being separated by a predetermined distance. A space formed between the shooting portion 21 and the background portion 22 becomes a shooting space where shooting processing is performed.

The pre-service portion 20 performs, as the pre-service processing, guidance introducing a game provided by the photo sticker creating device 1 and various settings of the shooting processing performed in the shooting space. The pre-service portion 20 includes a coin insertion slot to which the user inserts the charge and a touch panel monitor used for various operations. The pre-service portion 20 appropriately guides the user in the pre-service space to the shooting space according to availability of the shooting space.

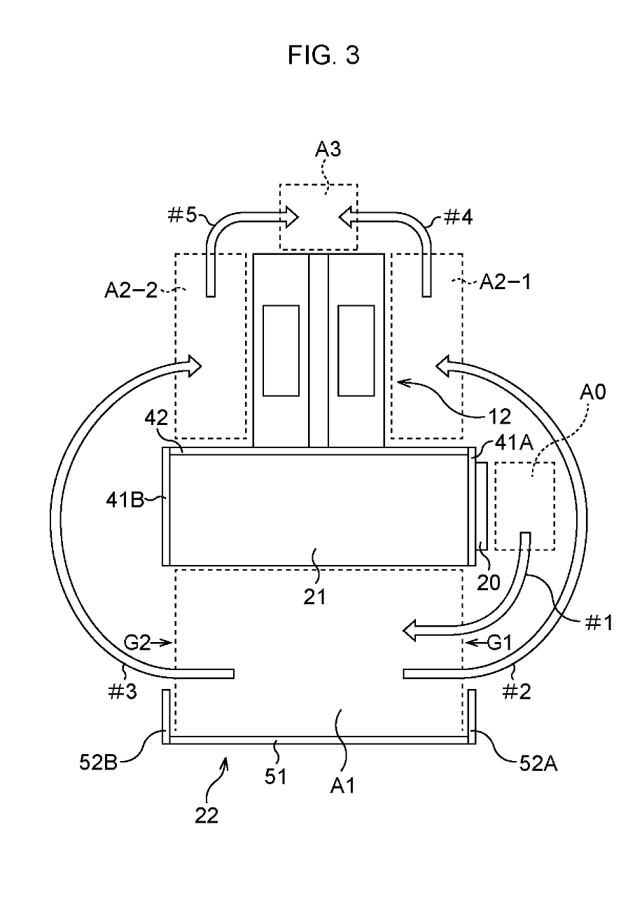

The shooting portion 21 shoots the user as an object. The shooting portion 21 is positioned in front of the user who has entered the shooting space. In the front surface of the shooting portion 21 which faces the shooting space, a camera, a touch panel monitor used for various operations, and the like are provided. When a surface of a right side as viewed from the user in the shooting space is a right side surface, and a surface of a left side is a left side surface, the right side surface of the shooting portion 21 is configured with a side surface panel 41A and the left side surface is configured with a side surface panel 41B (FIG. 3). The front surface of the shooting portion 21 is configured with a front panel 42. The above described pre-service portion 20 is installed on the side surface panel 41A. Note that, the pre-service portion 20 may be installed on the side surface panel 41B or on both of the side surface panels 41A and 41B.

The background portion 22 is configured with a back surface panel 51, a side surface panel 52A, and a side surface panel 52B (FIG. 3). The back surface panel 51 is a plate member positioned at a back surface side of the user facing the front. The side surface panel 52A is a plate member having a narrower breadth than the side surface panel 41A, and attached to a right end of the back surface panel 51. The side surface panel 52B is a plate member having a narrower breadth than the side surface panel 41B, and attached to a left end of the back surface panel 51.

The side surface panel 41A, which configures the right side surface of the shooting portion 21, and the side surface panel 52A of the background portion 22 are provided in substantially the same plane. The upper parts of the side surface panel 41A and the side surface panel 52A are coupled by a coupling portion 23A which is a plate member. The lower parts of the side surface panel 41A and the side surface panel 52A are coupled by a coupling portion 23A′ which is a member made of, for example, metal and provided on a floor surface. The side surface panel 41B, which configures the left side surface of the shooting portion 21, and the side surface panel 52B of the background portion 22 are similarly provided in substantially the same plane. The upper parts of the side surface panel 41B and the side surface panel 52B are coupled by a coupling portion 23B (not shown). The lower parts of the side surface panel 41B and the side surface panel 52B are coupled by a coupling portion 23B′ (not shown).

An opening formed by being surrounded by the side surface panel 41A, the coupling portion 23A, and the side surface panel 52A becomes an entrance of the shooting space. In addition, an opening formed by being surrounded by the side surface panel 41B, the coupling portion 23B, and the side surface panel 52B also becomes an entrance of the shooting space.

At the upper part of the background portion 22, a background curtain unit 25 is provided in the form of being supported by the back surface panel 51, the side surface panel 52A, and the side surface panel 52B. In the background curtain unit 25, a background curtain of a predetermined color, which appears in the background of the user in the shot image obtained by the shooting, is housed. The background curtain unit 25 appropriately lowers, for example, a green curtain for performing chroma key in the shooting space in conjunction with the shooting.

Note that, the chroma key curtain may be affixed in advance to the back surface panel 51 which is a back surface of the shooting space. When the shooting is performed using the chroma key curtain as the background, various types of background images are prepared, and chroma key processing is performed in the shooting processing or the editing processing. The user can thereby composite a desired background image on the part of the curtain.

Over the shooting space, a ceiling is formed being surrounded by the front surface of the shooting portion 21, the coupling portion 23A, the coupling portion 23B, and the background curtain unit 25. On a part of the ceiling, a ceiling strobe unit 24 is provided. One end of the ceiling strobe unit 24 is fixed to the coupling portion 23A, and the other end is fixed to the coupling portion 23B. The ceiling strobe unit 24 incorporates a strobe which irradiates the inside of the shooting space with light in accordance with the shooting. In the interior of the ceiling strobe unit 24, a fluorescent light is provided in addition to the strobe. The ceiling strobe unit 24 thereby functions as illumination of the shooting space.

The editing unit 12 edits the shot image. The editing unit 12 is coupled with the shooting unit 11 such that one side surface of the editing unit 12 comes in contact with the front panel 42 of the shooting portion 21.

When the editing unit 12 illustrated in FIGS. 1 and 2 is the front surface side, configurations used for editing work are provided at the front surface side and the back surface side of the editing unit 12. With this configuration, two pairs of users can perform editing work at the same time.

The front surface side of the editing unit 12 is configured with a surface 61, and a slope surface 62 formed above the surface 61. The surface 61 is vertical to the floor surface and substantially parallel to the side surface panel 41A of the shooting portion 21. On the slope surface 62, a tablet built-in monitor and a stylus, which are used for the editing work, are provided. On the right side of the slope surface 62, a columnar supporting portion 63A which supports one end of an illumination device 64 is provided. On the left side of the slope surface 62, a columnar supporting portion 63B which supports the other end of the illumination device 64 is provided. On the upper surface of the supporting portion 63A, a supporting section 65 which supports a curtain rail 26 is provided.

The curtain rail 26 is attached above the editing unit 12. The curtain rail 26 is configured by combining of three rails 26A to 26C. The three rails 26A to 26C are combined such that the shape of the three rails 26A to 26C as viewed from above becomes a substantially U shape. One end of the rail 26A and one end of the rail 26B, which are provided in parallel, are respectively fixed to the coupling portion 23A and the coupling portion 23B. The other end of the rail 26A is joined to one end of the rail 26C and the other end of rail 26B is joined to the other end of the rail 26C.

A curtain is attached to the curtain rail 26 such that interiors of a space in front of the front surface of the editing unit 12 and a space in front of the back surface of the editing unit 12 cannot be seen from outside. The space in front of the front surface of the editing unit 12 and the space in front of the back surface of the editing unit 12 which are surrounded by the curtain become editing spaces in which the user performs the editing work.

Although the detail will be described later, in a right side surface of the editing unit 12, an outlet through which a printed sticker sheet is discharged is provided. A space in front of the right side surface of the editing unit 12 becomes a print-waiting space where the user waits for the printed sticker sheet to be discharged.

### <Movements of User>

Here, a flow of a photo sticker creation game and movements of the user associated with the game will be described. FIG. 3 is a plan view of the photo sticker creating device 1 as viewed from above.

First, the user inserts the charge to the coin insertion slot at the pre-service space A0 which is a space in front of the pre-service portion 20. Then the user performs various settings according to a screen displayed on the touch panel monitor. As a pre-service work, the user selects, for example, a course of shooting processing performed in the shooting space and a background of the shot image.

As illustrated by an outline arrow #1, the user who has completed the pre-service work enters a shooting space A1 formed between the shooting portion 21 and the background portion 22 from an entrance G1 between the side surface panel 41A and the side surface panel 52A. Then the user performs shooting work using a camera and a touch panel monitor which are provided in the shooting portion 21.

As illustrated by an outline arrow #2, the user who has completed the shooting work exits the shooting space A1 from the entrance G1 and moves to an editing space A2-1 or as illustrated by an outline arrow #3, exits the shooting space A1 from the entrance G2 and moves to an editing space A2-2.

The editing space A2-1 is an editing space of the front surface side of the editing unit 12. On the other hand, the editing space A2-2 is an editing space of the back surface side of the editing unit 12. The user is guided to either of the editing space A2-1 or the editing space A2-2, for example, by a screen display of the touch panel monitor of the shooting portion 21. For example, the user is guided to an available space of the two editing spaces as a destination. The user who has moved to the editing space A2-1 or the editing space A2-2 starts the editing work. The user in the editing space A2-1 and the user in the editing space A2-2 can perform the editing work at the same time.

After completion of the editing work, printing of the edited images is started. When the printing is started, as illustrated by an outline arrow #4, the user who has completed the editing work in the editing space A2-1 moves from the editing space A2-1 to a print-waiting space A3. As illustrated by an outline arrow #5, the user who has completed the editing in the editing space A2-2 moves from the editing space A2-2 to the print-waiting space A3.

The user who has moved to the print-waiting space A3 waits for the printing of the image to be completed. When the printing has been completed, the user receives a sticker sheet through the outlet provided in the right side surface of the editing unit 12, and terminates a series of the photo sticker creation game.

Next, configurations of respective units and sections will be described.

### <Configuration of Pre-Service Portion>

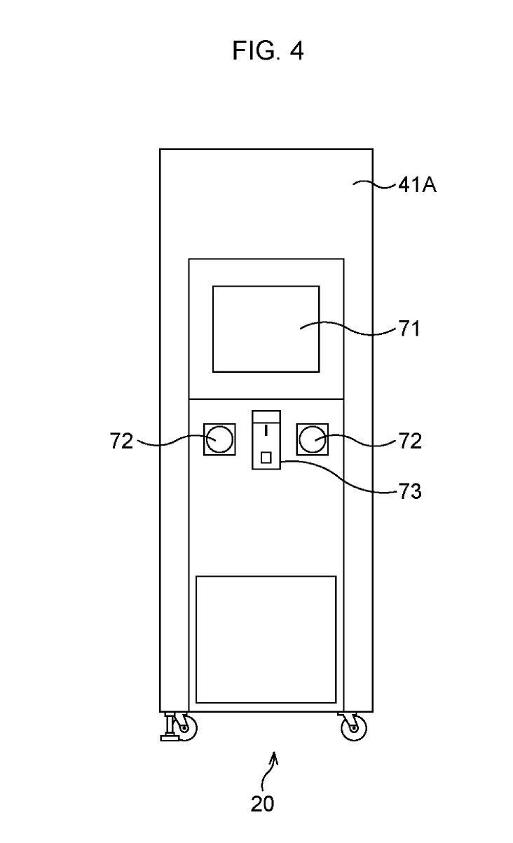

FIG. 4 is a diagram illustrating a configuration example of a front surface side of the pre-service portion 20.

On the upper part of the pre-service portion 20, a touch panel monitor 71 is provided. The touch panel monitor 71 is configured with a monitor, such as a liquid crystal display (LCD) and a touch panel layered thereto. The touch panel monitor 71 has a function to display various graphical user interfaces (GUIs) and a function to receive a selection operation by a user. On the touch panel monitor 71, a screen used for pre-service processing, in which a course of the shooting processing, a background of the shot image, and the like are selected, is displayed.

On the lower part of the touch panel monitor 71, two speakers 72 are provided. The two speakers 72 output sound guidance of the pre-service processing, back ground music (BGM), sound effects, and the like. Between the two speakers 72, a coin insertion/return slot 73 to which the user inserts coins is provided.

### <Configuration of Shooting Portion>

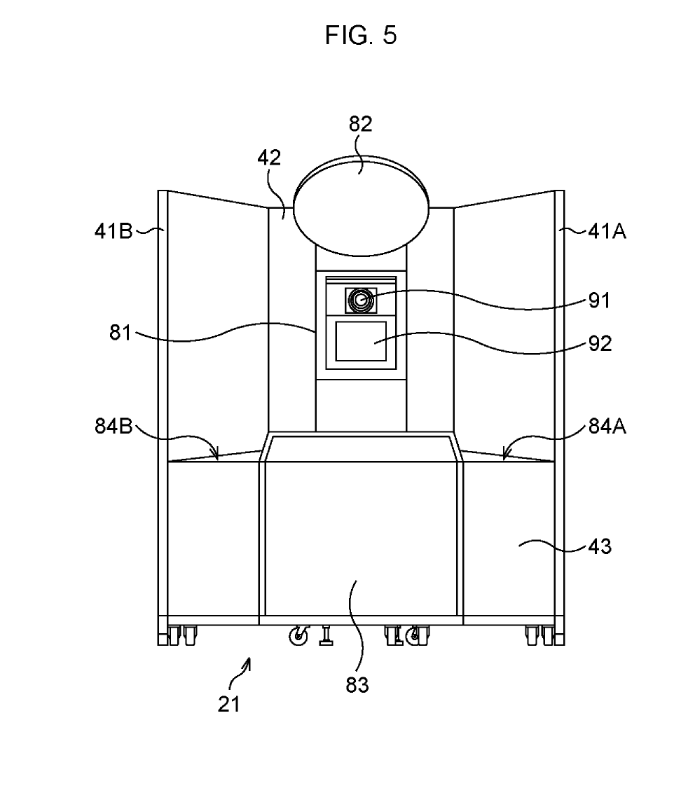

FIG. 5 is a diagram illustrating a configuration example of a front of the shooting portion 21. The shooting portion 21 is configured such that the side surface panel 41A, the side surface panel 41B, and the front panel 42 are attached to a base portion 43 having a box like shape.

In the center of the front panel 42, a camera unit 81 is provided. The camera unit 81 is configured with a camera 91 and a touch panel monitor 92.

The camera 91 is, for example, a single-lens reflex camera, and is attached to the interior of the camera unit 81 such that a lens is exposed. The camera 91 includes an imaging device, such as a charge coupled device (CCD) image sensor or a complementary metal oxide semiconductor (CMOS) image sensor, and shoots the user in the shooting space A1. A moving image (hereinafter referred to as a live view image) captured by the camera 91 is displayed on the touch panel monitor 92 in real time. A still image captured by the camera 91 at predetermined timing, such as when the shooting is instructed, is stored as the shot image.

The touch panel monitor 92 is provided below the camera 91. The touch panel monitor 92 is configured with a monitor, such as an LCD, and a touch panel layered thereto. The touch panel monitor 92 has a function as a live view monitor to display the moving image captured by the camera 91, and a function to display various GUIs and to receive a selection operation by the user. The moving image (live view image) and the still image (shot image) captured by the camera 91 are displayed on the touch panel monitor 92.

Above the camera unit 81, an upper strobe 82, a curved light-emitting surface of which faces the user, is installed. The upper strobe 82 irradiates the face and the upper half of the body of the user from above. Furthermore, a foot strobe 83 which irradiates the lower half of the body and the foot of the user is provided in the center of a base portion 43.

At the right and left parts on the upper surface of the base portion 43, spaces 84A and 84B are formed. The spaces 84A and 84B are formed so as to interpose the upper surface of the foot strobe 83. The spaces 84A and 84B are used as baggage storage places where the user places hand baggage and the like. Although not illustrated, a speaker is provided, for example, in the vicinity of the ceiling of the front panel 42. The speaker outputs sound guidance of the shooting processing, BGM, sound effects, and the like.

### <Configuration of Background Portion>

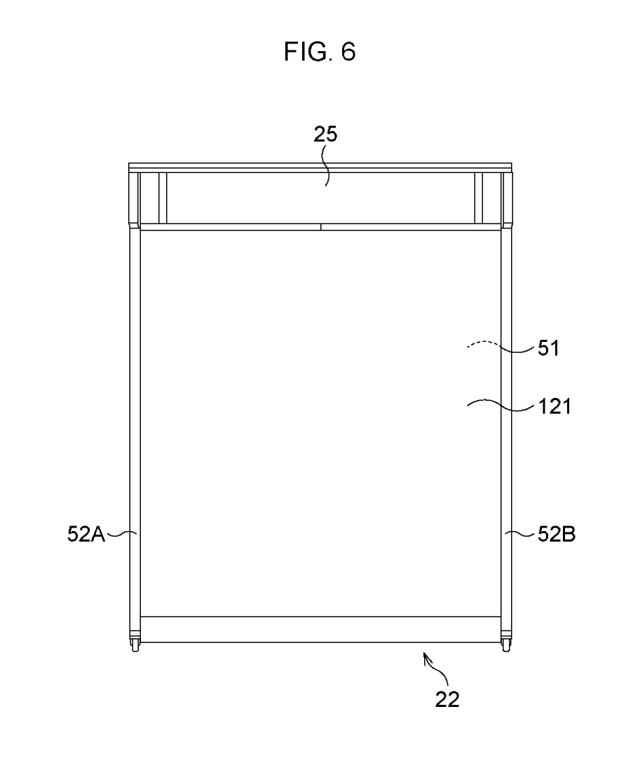

FIG. 6 is a diagram illustrating a configuration example of a shooting space A1 side of the background portion 22.

As described above, the background curtain unit 25 is provided at the upper part of the back surface panel 51.

Furthermore, a back surface curtain 121 is affixed to a surface of the back surface panel 51 on the shooting space A1 side (the front side in the drawing). The color of the back surface curtain 121 is a white-based color which is similar to studios and the like where fashion magazine models and the like are shot. Accordingly, a shadow more easily appears in the background of the object and stereoscopic effects can be emphasized in the shot image obtained by the shooting. The white-based color includes not only white but also colors close to white (specifically, gray close to white, bluish gray close to white, and the like).

Although not illustrated, side surface curtains similar to the back surface curtain 121 are affixed to the respective side surface panels 52A and 52B on the shooting space A1 side. The color of the side surface curtain is the same as that of the back surface curtain 121.

### <Configuration of Editing Unit>

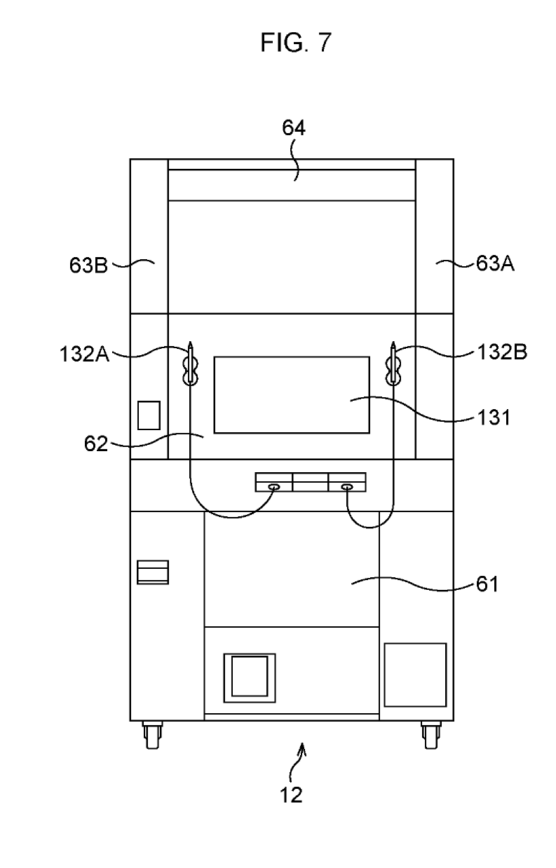

FIG. 7 is a diagram illustrating a configuration example of the front surface side (an editing space A2-1 side) of the editing unit 12.

In substantially the center of the slope surface 62, a tablet built-in monitor 131 is provided. At the left side of the tablet built-in monitor 131, a stylus 132A is provided. At the right side of the tablet built-in monitor 131, a stylus 132B is provided.

The tablet built-in monitor 131 is configured by providing a tablet which exposes a display. The tablet enables to perform an operation input using the stylus 132A or the stylus 132B. On the tablet built-in monitor 131, for example, an editing screen used for the editing work is displayed. When the editing work is simultaneously performed by two users, the stylus 132A is used by the user who stands on the left side facing the tablet built-in monitor 131, and the stylus 132B is used by the user who stands on the right side facing the tablet built-in monitor 131.

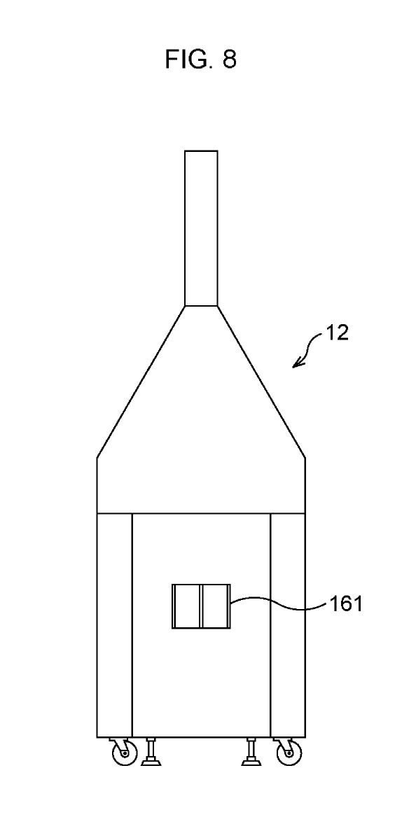

FIG. 8 is a diagram illustrating configuration examples of the right side surface of the editing unit 12.

On the lower part of the right side surface of the editing unit 12, a sticker sheet outlet 161 is provided. In the interior of the editing unit 12, a printer is provided. With the printer, an image in which the user in the editing space A2-1 appears, or an image in which the user in the editing space A2-2 appears are printed on a sticker sheet with a predetermined layout and the sticker sheet is discharged through the sticker sheet outlet 161.

### <Internal Configuration of Photo Sticker Creating Device>

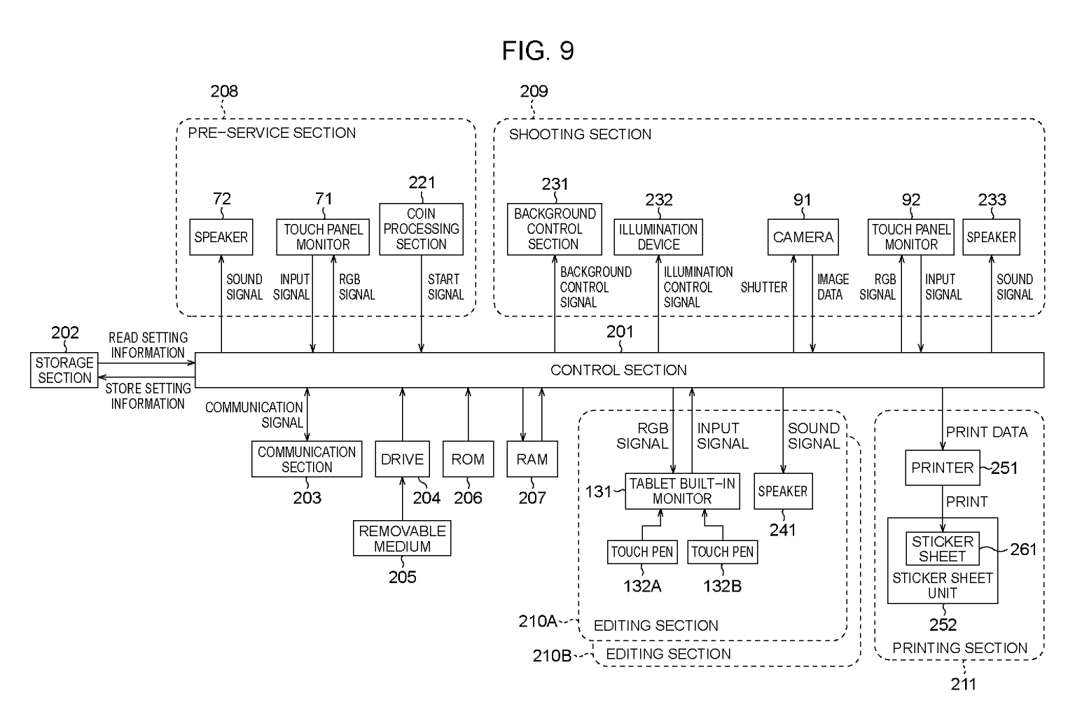

FIG. 9 is a block diagram illustrating an internal configuration example of the photo sticker creating device 1. In FIG. 9, the same reference signs are assigned to the same configurations as the above described configurations. Overlapping description is appropriately omitted.

A control section 201 is implemented by a central processing unit (CPU) and the like. The control section 201 executes a program stored in read only memory (ROM) 206 or a storage section 202 and controls the entire operations of the photo sticker creating device 1. To the control section 201, the storage section 202, a communication section 203, a drive 204, the ROM 206, and random access memory (RAM) 207 are connected. Furthermore, to the control section 201, a pre-service section 208, a shooting section 209, editing sections 210A and 210B, and a printing section 211 are connected.

The storage section 202 is a non-volatile storage medium, such as a hard disk or flash memory. The storage section 202 stores various types of setting information supplied from the control section 201, and the like. The information stored in the storage section 202 is appropriately read by the control section 201.

The communication section 203 is an interface of a network, such as the Internet. The communication section 203 communicates with an external device according to the control of the control section 201. The communication section 203 transmits to the server, for example, the shot image and the edited image which are selected by the user. The image transmitted from the communication section 203 is stored in a predetermined allocated storage area in the server, and is displayed or downloaded on a mobile terminal accessing the server.

To the drive 204, a removable medium 205 implemented by an optical disk or a semiconductor memory is appropriately attached. A program and data read from the removable medium 205 by the drive 204 is supplied to the control section 201, and are stored in the storage section 202 or installed.

The ROM 206 stores a program executed by the control section 201 and data. The RAM 207 temporarily stores a program and data which are processed by the control section 201.

The pre-service section 208 performs pre-service processing to the user in the pre-service space A0. The pre-service section 208 is configured with the touch panel monitor 71, the speaker 72, and the coin processing section 221.

The touch panel monitor 71 displays various selection screens according to the control of the control section 201 and receives an operation of the user to the selection screen. The input signal indicating the operation of the user is supplied to the control section 201 and various settings are performed.

The coin processing section 221 detects insertion of a coin to the coin insertion/return slot 73. When having detected the insertion of coins of a predetermined amount of money, the coin processing section 221 outputs, to the control section 201, a start signal which instructs to start a game.

The shooting section 209 performs the shooting processing to the user in the shooting space A1. The shooting section 209 is configured with the background control section 231, the illumination device 232, the camera 91, the touch panel monitor 92, and a speaker 233.

The background control section 231 controls to raise and lower the background curtain by the background curtain unit 25 according to a background control signal supplied from the control section 201.

The illumination device 232 includes strobes in the shooting space A1, and emits light according to an illumination control signal supplied from the control section 201. In the shooting space A1, the upper strobe 82 and the foot strobe 83 of the shooting portion 21 are provided, in addition to the strobe of the ceiling strobe unit 24.

The camera 91 performs the shooting according to the shutter control of the control section 201, and outputs, to the control section 201, the shot image (image data) obtained by the shooting.

The editing section 210A performs the editing processing intended for the user in the editing space A2-1. The editing section 210A is configured with the tablet built-in monitor 131, the styli 132A and 132B, and a speaker 241. The editing section 210B performs the editing processing intended for the user in the editing space A2-2 and has the same configuration as the editing section 210A. Hereinafter, the editing sections 210A and 210B are simply referred to as the editing section 210, unless particularly distinguished.

The tablet built-in monitor 131 displays an editing screen according to the control of the control section 201, and receives an operation of the user to the editing screen. A signal indicating content of the operation of the user is supplied to the control section 201, and the shot image to be edited is edited.

The printing section 211 performs printing processing of providing the user in the print-waiting space A3 with a printed sticker sheet. The printing section 211 is configured by including a printer 251. A sticker sheet unit 252 is attached to the printer 251.

The printer 251 prints, based on print data supplied from the control section 201, the edited image on a sticker sheet 261 stored in the sticker sheet unit 252 and discharges the printed sheet through the sticker sheet outlet 161.

### <Configuration of Control Section>

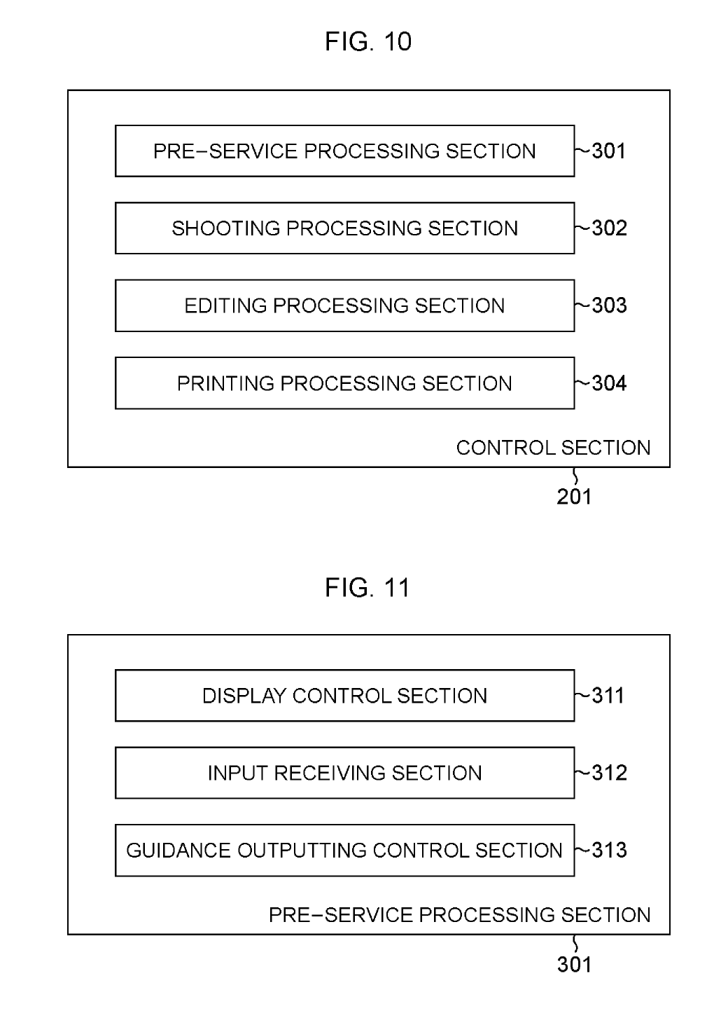

FIG. 10 is a block diagram illustrating a functional configuration example of the control section 201. At least one of functional sections illustrated in FIG. 10 is realized by executing a predetermined program by the CPU in the control section 201. The photo sticker creating device 1 thereby functions as an image providing device.

The control section 201 is configured with a pre-service processing section 301, a shooting processing section 302, an editing processing section 303, and a printing processing section 304.

The pre-service processing section 301 performs pre-service processing by controlling sections of the pre-service section 208. The shooting processing section 302 performs the shooting processing by controlling sections of the shooting section 209. The editing processing section 303 performs the editing processing by controlling sections of the editing section 210. The printing processing section 304 performs printing processing by controlling the printer 251 of the printing section 211.

### <Configuration Example of Pre-Service Processing Section>

FIG. 11 is a block diagram illustrating a functional configuration example of the pre-service processing section 301.

The pre-service processing section 301 is configured with a display control section 311, an input receiving section 312, and a guidance outputting control section 313.

The display control section 311 controls display of the touch panel monitor 71. For example, the display control section 311 displays, on the touch panel monitor 71, a selection screen for a course selection of the shooting processing performed in the shooting space and for a background selection of the shot image.

The input receiving section 312 receives an operation of the user to the touch panel monitor 71. More specifically, the input receiving section 312 receives the selection operation input to a selection screen displayed on the touch panel monitor 71.

The guidance outputting control section 313 controls an output of guidance for explaining various selection operations. The guidance outputting control section 313 displays a screen for explaining various selection operations on the touch panel monitor 71 and outputs sound for explaining various selection operations from the speaker 72.

### <Configuration Example of Shooting Processing Section>

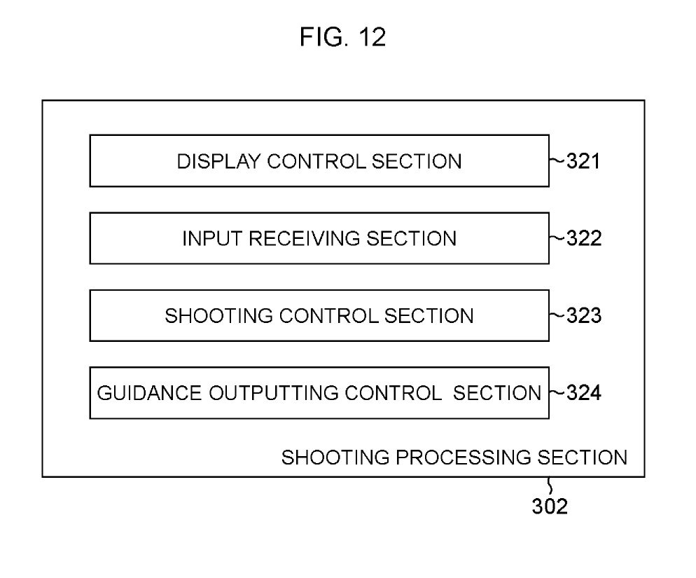

FIG. 12 is a block diagram illustrating a functional configuration example of the shooting processing section 302.

The shooting processing section 302 is configured with the display control section 321, the input receiving section 322, the shooting control section 323, and the guidance outputting control section 324.

The display control section 321 controls display of the touch panel monitor 92. For example, the display control section 321 displays, on the touch panel monitor 92, the moving image captured by the camera 91 as the live view and the shot image as a shooting result.

The input receiving section 322 receives an operation of the user to the touch panel monitor 92.

The shooting control section 323 controls the camera 91, shoots the user as an object, and obtains the shot image.

The guidance outputting control section 324 controls an output of guidance for explaining how to proceed with the shooting work and the like. The guidance outputting control section 324 displays a screen for explaining how to proceed with the shooting on the touch panel monitor 92 and outputs sound for explaining how to proceed with the shooting from the speaker 233.

### <Configuration Example of Editing Processing Section>

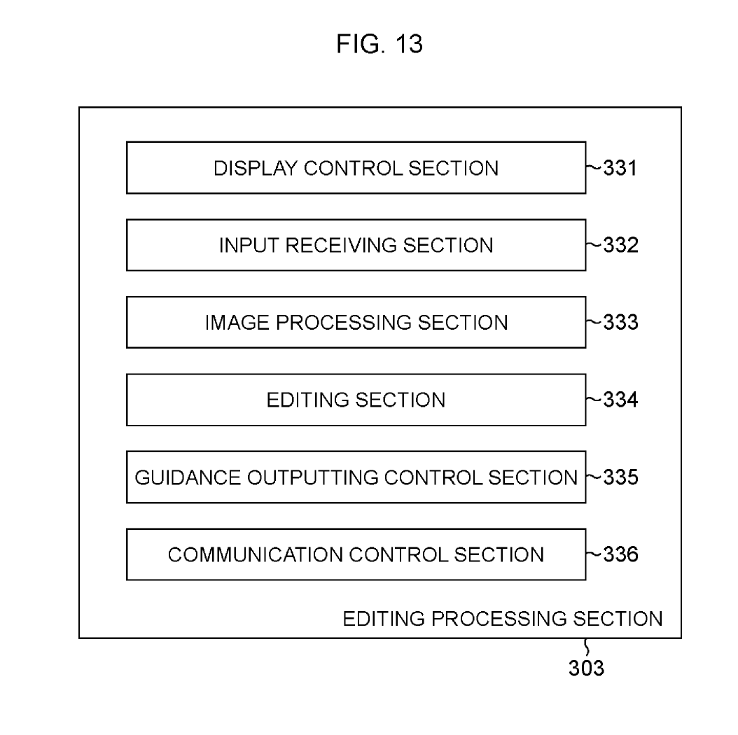

FIG. 13 is a block diagram illustrating a functional configuration example of the editing processing section 303.

The editing processing section 303 is configured with a display control section 331, an input receiving section 332, an image processing section 333, an editing section 334, a guidance outputting control section 335, and a communication control section 336.

The display control section 331 controls display of the tablet built-in monitor 131. For example, the display control section 331 displays, on the tablet built-in monitor 131, a selection screen to select contents of image processing to be performed to the shot image and an editing screen to edit the shot image.

The input receiving section 332 receives an operation of the user to the tablet built-in monitor 131 with the styli 132A and 132B. For example, the input receiving section 312 receives a content selection of image processing to the selection screen and an input to the editing screen.

The image processing section 333 performs predetermined image processing to the shot image according to a selection operation to the selection screen.

The editing section 334 edits the shot image according to an input operation to the editing screen.

The guidance outputting control section 335 controls an output of guidance for explaining how to proceed with the editing work. The guidance outputting control section 335 displays, on the tablet built-in monitor 131, a screen for explaining how to proceed with the editing work and outputs sound for explaining how to proceed with the editing work to the speaker 241.

The communication control section 336 controls the communication section 203 and performs communication processing through a network such as the Internet. For example, the communication control section 336 transmits the shot image obtained in the shooting processing and the edited image obtained in the editing processing to an external server by controlling the communication section 203.

### <Operations of Photo Sticker Creating Device>

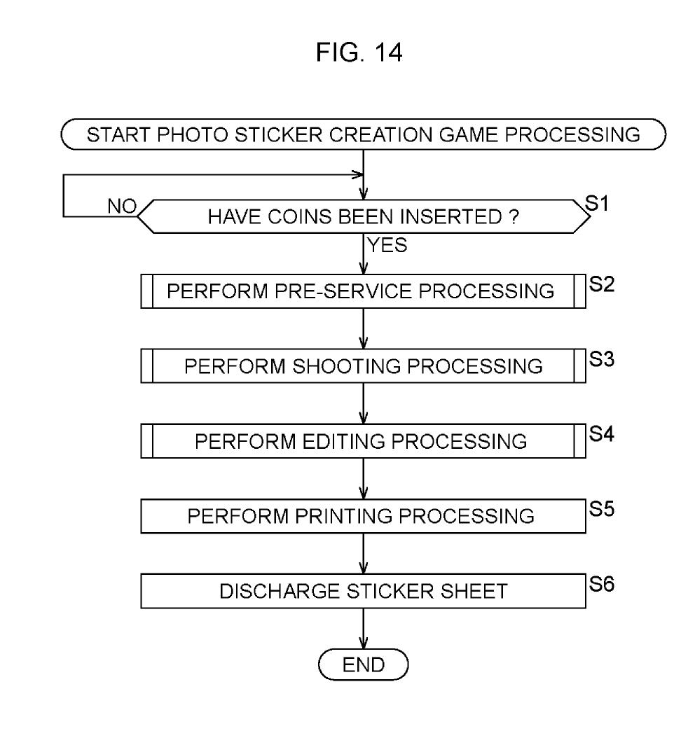

Here, operations of the photo sticker creating device 1 which provides a photo sticker creation game will be described with reference to the flowchart of FIG. 14.

In step S1, the pre-service processing section 301 determines whether coins of a predetermined amount of money have been inserted based on the start signal supplied from the coin processing section 221 and waits until determining that the coins have been inserted.

When having determined that the coins have been inserted in step S1, the processing proceeds to step S2. In step S2, the pre-service processing section 301 performs pre-service processing by controlling the pre-service section 208. More specifically, the pre-service processing section 301 performs various settings by allowing the user to select a course of the shooting processing performed in the shooting space and a background of the shot image.

In step S3, the shooting processing section 302 performs the shooting processing by controlling the shooting section 209. More specifically, the shooting processing section 302 displays the moving image of the object captured by the camera 91 on the touch panel monitor 92 as the live view, shoots the user in the shooting space A1 as the object, and obtains the shot image.

In step S4, the editing processing section 303 performs the editing processing by controlling the editing section 210 corresponding to the editing space as the destination of the user in the editing space A2-1 or the editing space A2-2 who has completed the shooting processing. More specifically, the editing processing section 303 generates the edited image which has been edited by allowing the user to perform the editing work to the shot image obtained by the shooting processing.

In step S5, the printing processing section 304 performs (starts) printing processing by controlling the printer 251. More specifically, the printing processing section 304 outputs the edited image obtained by the editing processing to the printer 251 and prints the edited image on a sticker sheet. Note that, the shot image obtained by the shooting processing may be printed on a sticker sheet.

When the printing has been completed, in step S6, the printer 251 discharges the sticker sheet through the sticker sheet outlet 161 and the processing is terminated.

### <Details of Pre-Service Processing>

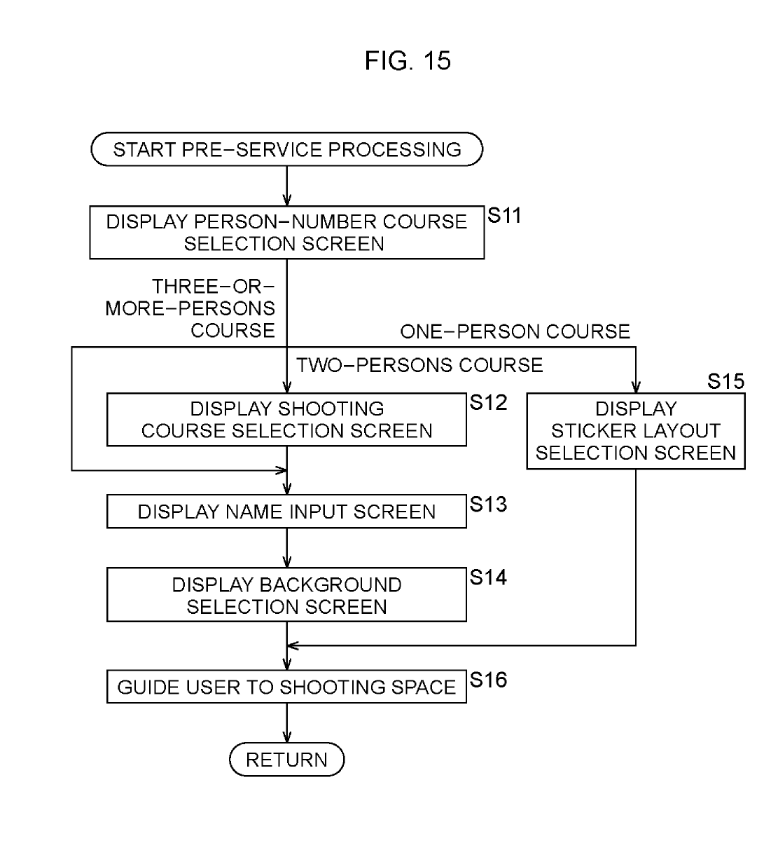

Next, details of the pre-service processing in step S2 in the above described series of processing of the photo sticker creation game will be described with reference to the flowchart of FIG. 15.

When the pre-service processing is started, in step S11, the display control section 311 displays a person-number course selection screen on the touch panel monitor 71.

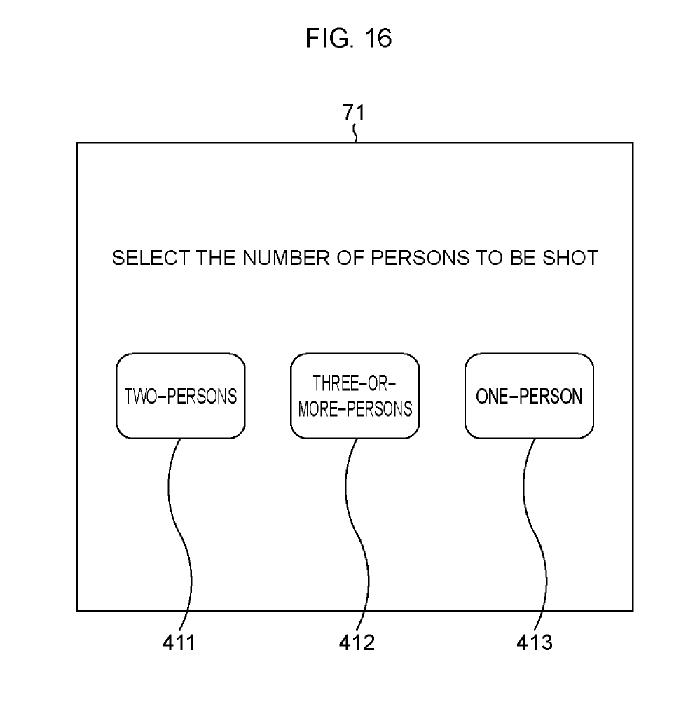

FIG. 16 is a diagram illustrating an example of the person-number course selection screen.

On the person-number course selection screen, a message “Select the number of persons to be shot” is displayed and buttons 411 to 413 are displayed thereunder. The button 411 is operated when a two-persons course is selected as a person-number course. The button 412 is operated when a three-or-more-persons course is selected. The button 413 is operated when a one-person course is selected.

By operating any one of the buttons 411 to 413, the input receiving section 312 receives the selection of the person-number course. When the two-persons course is selected, a game for two users is provided. When the three-or-more-persons course is selected, a game for three or more users is provided. When the one-person course is selected, a game for a single user is provided.

On the person-number course selection screen, when the selection of the two-persons course is received by operating the button 411, the processing proceeds to step S12. In step S12, the display control section 311 displays a shooting course selection screen on the touch panel monitor 71.

The shooting course selection screen is used to select the shooting course which determines a shooting type in the shooting processing. The shooting course includes, for example, a normal course which performs conventional shooting and a preference course which performs shooting with a different method from the conventional shooting.

By operating the shooting course selection screen, the input receiving section 312 receives the selection of the shooting course. When any one of the selection of the shooting courses is received, the processing proceeds to step S13.

On the other hand, on the person-number course selection screen, when the selection of the three-or-more-persons course is received by operating the button 412, step S12 is skipped and the processing proceeds to step S13. When the three-or-more-persons course is selected, a normal course shooting is performed in the shooting processing.

In step S13, the display control section 311 displays a name input screen on the touch panel monitor 71.

The name input screen is used to input a name by the user. By operating the name input screen, the input receiving section 312 receives the input of the respective names of the users.

In step S14, the display control section 311 displays a background selection screen on the touch panel monitor 71.

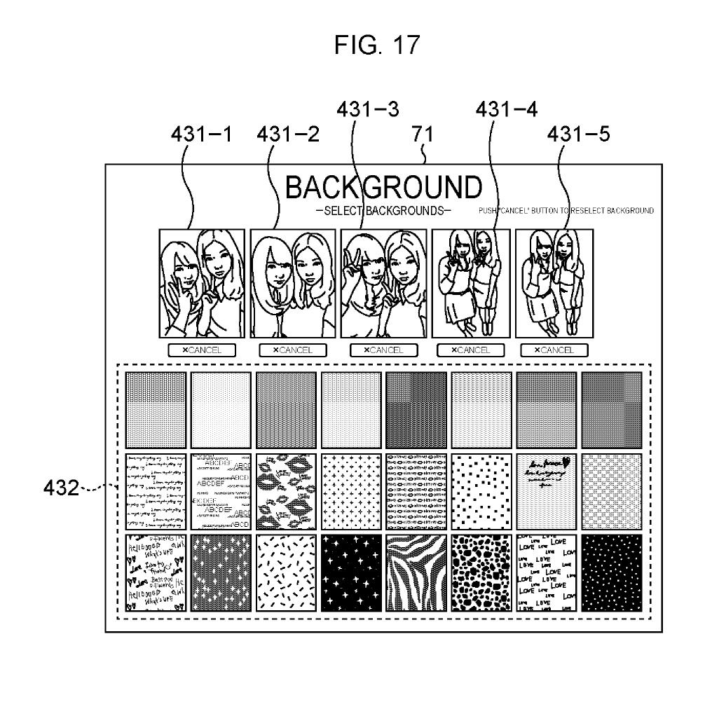

FIG. 17 is a diagram illustrating an example of the background selection screen.

On the upper part of the background selection screen, a message “Select backgrounds” is displayed and model images 431-1 to 431-5 are displayed thereunder. The model images 431-1 to 431-5 are obtained by shooting two models as the objects. Among the model images 431-1 to 431-5, the three model images 431-1 to 431-3 are close-up images in which the faces and the upper half of the bodies of the objects appear and the two model images 431-4 and 431-5 are whole-body images in which the whole bodies of the objects appear.

That is, in the shooting processing of the two-persons course or the three-or-more-persons course, five shot images are obtained by performing the shooting five times. Three of the five shot images are the close-up images and the other two images are the whole-body images.

Under the model images 431-1 to 431-5, a plurality of background images 432 to be composited on the background of the shot image are displayed. In the examples of FIG. 17, 24 background images arranged in three rows and eight columns are displayed.

On the background selection screen, by the operation of the user, when any one of the background images 432 is selected while any one of the model images 431-1 to 431-5 is being selected, the selected background image is composited on the background of the selected model image.

In this way, the input receiving section 312 receives the selection of the background image to be composited on the respective five shot images, obtained in the shooting processing, corresponding to the model images 431-1 to 431-5.

The user can cancel, by operating cancel buttons displayed under the respective model images 431-1 to 431-5, the selected background image of the model image (shot image) corresponding to the cancel button.

When a predetermined time has passed after the background selection screen is displayed, the processing proceeds to step S16. When a background image is not selected for a model image until the predetermined time has passed, it is assumed that a predetermined background image is selected for the model image.

Here, on the person-number course selection screen, when the selection of the one-person course is received by operating the button 413, the processing proceeds to step S15. In step S15, the display control section 311 displays a sticker layout selection screen on the touch panel monitor 71.

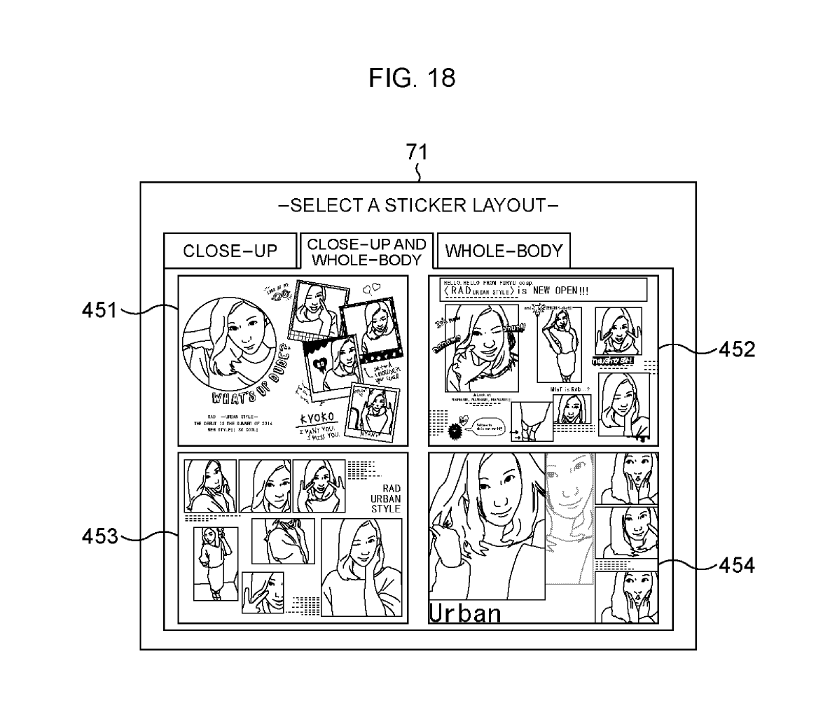

FIG. 18 is a diagram illustrating an example of the sticker layout selection screen.

On the upper part of the sticker layout selection screen, a message “Select a sticker layout” is displayed and sticker layout images 451 to 454 are displayed thereunder. In the example of FIG. 18, a plurality of the model images are arranged in the respective sticker layout images 451 to 454.

The sticker layout image is an image in which the shot image or the plurality shot images is arranged and printed on a sticker sheet. In the sticker layout image, the shot image is arranged on a predetermined area (hereinafter, referred to as a shot image arrangement area) and well-designed characters and patterns are arranged on the other area. The sticker layout image does not include the shot image. On a sticker sheet, a composite image obtained by arranging and compositing the shot image on the shot image arrangement area of the sticker layout image is printed. Note that, the composite image obtained by arranging and compositing the shot image on the shot image arrangement area of the sticker layout image may be transmitted to a mobile terminal of the user through the server. In this way, the sticker layout image in which the shot image is arranged on the shot image arrangement area is output.

On the sticker layout selection screen, the sticker layout images are displayed by tabs “close-up”, “close-up and whole-body”, and “whole-body” categorized according to the shot image to be arranged in the sticker layout image. When the “close-up” tab is selected, the sticker layout images in which the close-up images are arranged are displayed. When the “close-up and whole-body” tab is selected, the sticker layout images in which the close-up images and the whole-body images are arranged are displayed. When the “whole-body” tab is selected, the sticker layout images in which the whole-body images are arranged are displayed.

To the shot image arrangement area of the sticker layout image, an image shooting range to determine which part of the body of the user is to be shot is set. In other words, to the shot image arrangement area on which the close-up image to be arranged, the face and the upper half of the body of the user is set as the image shooting range. To the shot image arrangement area on which the whole-body image is to be arranged, the whole-body of the user is set as the image shooting range.

The number of shot images to be arranged in the sticker layout image, that is, the number of shot image arrangement areas in the sticker layout image may be different from that in the respective sticker layout images. Furthermore, the number of close-up images and whole-body images arranged in the sticker layout image displayed by the “close-up and whole-body” tab may be also different from that in the respective sticker layout images.

Therefore, in the shooting processing of the one-person course, the shooting is performed the number of times according to the number of shot images to be arranged in the selected sticker layout image. Note that, in the sticker layout image, a plurality of same shot images may be arranged.

In the example of FIG. 18, although the “close-up and whole-body” tab is selected, in sticker layout images 451 and 454, only the close-up images are arranged as the model images. However, the close-up images and the whole-body images are to be arranged in fact.

When a predetermined time has passed after the sticker layout image selection screen is displayed, the processing proceeds to step S16. When a sticker layout image is not selected until the predetermined time has passed, it is assumed that a predetermined sticker layout image is selected.

After the processing in step S14 or step S15, the processing proceeds to step S16. In step S16, the guidance outputting control section 313 guides the user in the pre-service space A0 to the shooting space A1. The guide to the shooting space A1 is performed by displaying a guide screen on the touch panel monitor 71 or by outputting sound from the speaker 72.

### <Details of Shooting Processing>

Next, details of the shooting processing in step S3 in the above described series of processing of the photo sticker creation game will be described. Note that, according to the person-number course selected in the pre-service processing, different shooting processing is performed.

### (Shooting Processing of Two-Persons Course or Three-or-More-Persons Course)

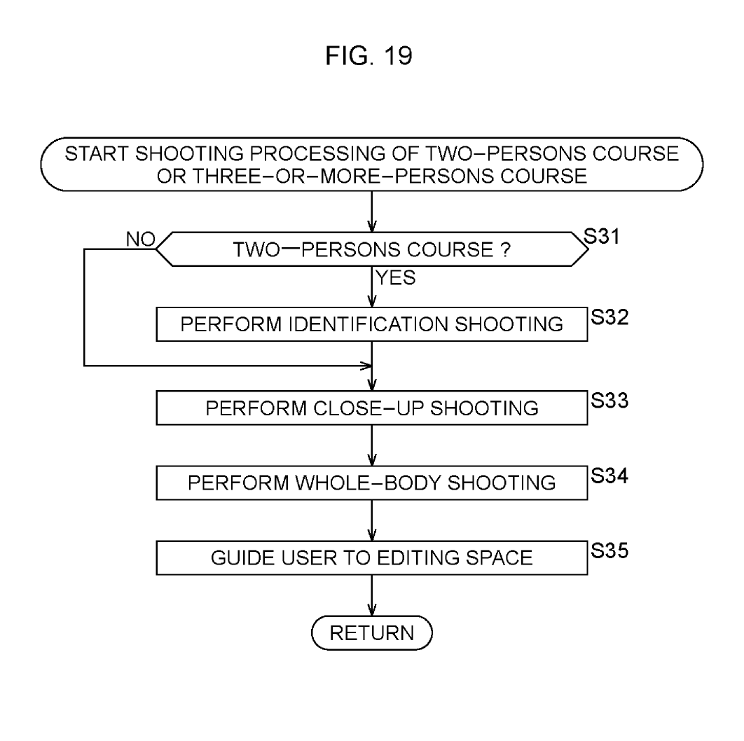

First, shooting processing of the two-persons course or the three-or-more-persons course will be described with reference to the flowchart of FIG. 19.

In step S31, the shooting processing section 302 determines whether the person-number course is the two-persons course or not.

When the person-number course is the two-persons course, the guidance outputting control section 324 displays a screen for explaining how to proceed with identification shooting on the touch panel monitor 92. Then, the processing proceeds to step S32 and the shooting control section 323 performs the identification shooting.

When a plurality of users becomes an object, the identification shooting is performed in order to identify the faces of the respective users, and to further identify the face organs (such as eyes and a mouth) of the user. A shot image obtained by the identification shooting (hereinafter, referred to as an identification image) is neither edited in the editing processing nor printed on the sticker sheet in the printing processing. The identification image is used only to identify the faces and the face organs.

To achieve such a purpose, in the above described guidance of the identification shooting, a screen to request the user to perform the shooting facing the front is displayed and sound to request the same is output.

When the guidance is completed, the shooting control section 323 starts to capture the moving image by the camera 91. Then, the display control section 321 displays the moving image, in which the user appears, captured by the camera 91 on a live view display screen.

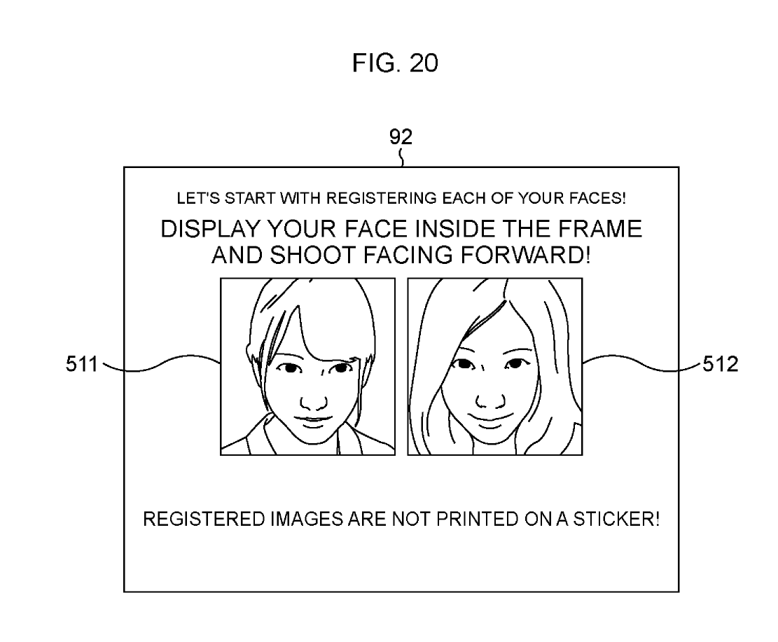

FIG. 20 is a diagram illustrating an example of the live view display screen of the identification shooting. On the upper part of the live view display screen, a message “Let's start with registering each of your faces! Display your face inside the frame and shoot facing forward!” is displayed. On image display areas 511 and 512 provided under the message, the moving images, in which the respective two users appear, are displayed in real time. Under the image display areas 511 and 512, a message “Registered images are not printed on a sticker!” is displayed.

A predetermined areas of the respective moving images captured by the camera 91 are cut-out and displayed on the image display areas 511 and 512. The two users adjust their face positions to fit the respective faces inside the image display areas 511 and 512 checking the display of the image display areas 511 and 512.

After the live view image is displayed for a predetermined time, a countdown to the shooting is started. Then, at the timing of the shooting, the shooting control section 323 performs the identification shooting and obtains the still images as the images for identification. The display control section 321 displays a shooting result of the identification shooting on the touch panel monitor 92.

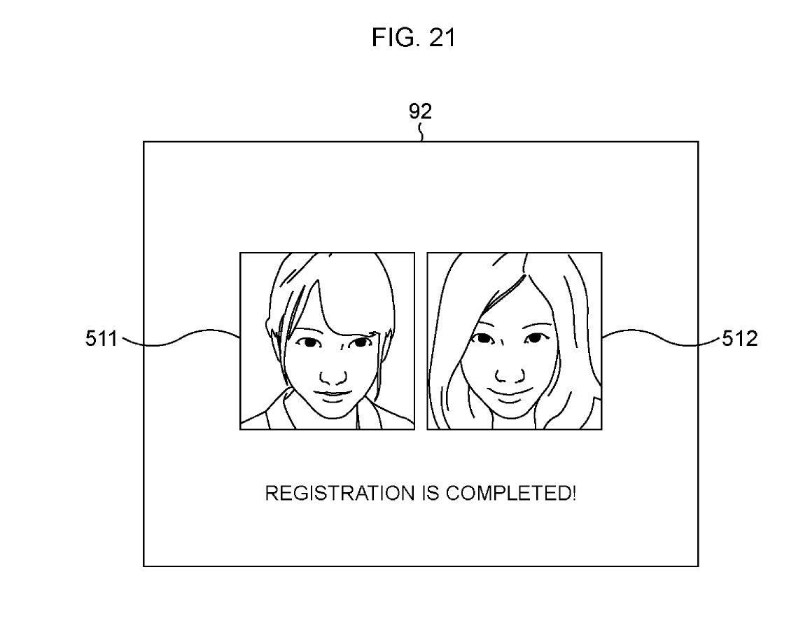

FIG. 21 is a diagram illustrating an example of a shooting result confirmation screen of the identification shooting.

On the image display areas 511 and 512 of the shooting result confirmation screen, the still images (images for identification) obtained by the identification shooting are displayed. Under the image display areas 511 and 512, a message “Registration is completed!” is displayed.

As described above, the identification shooting is performed.

Note that, when the person-number course is the three-or-more-persons course, step S32 is skipped and the identification shooting is not performed.

When the identification shooting is completed or the shooting processing of the three-or-more-persons course is started, the guidance outputting control section 324 displays, on the touch panel monitor 92, a screen for explaining how to perform close-up shooting to obtain a close-up image. Then, in step S33, the shooting control section 323 performs the close-up shooting.

More specifically, when the guidance is completed, the shooting control section 323 starts to capture the moving image by the camera 91. Then, the display control section 321 displays the moving image, in which the users appear, captured by the camera 91 on the live view display screen.

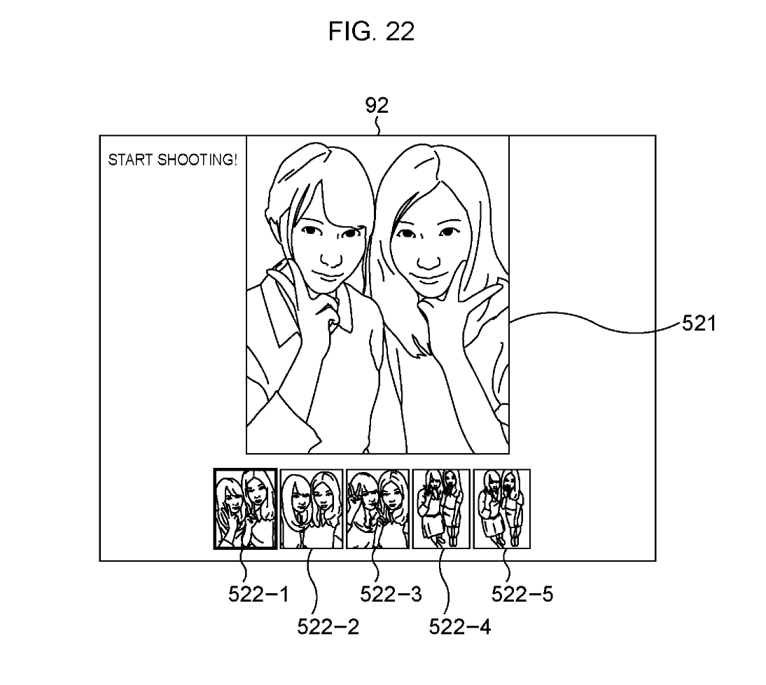

FIG. 22 is a diagram illustrating an example of the live view display screen of the close-up shooting.

On the upper-left part of the live view display screen, a message “Start shooting!” is displayed. On an image display area 521 provided in substantially the center of the live view display screen, the moving image, in which the two users appear, is displayed in real time. Furthermore, on five image display areas 522-1 to 522-5 provided under the image display area 521, the model images displayed on the background selection screen of FIG. 17 are displayed.

Among the five the model images displayed on the image display areas 522-1 to 522-5, the three model images displayed on the image display areas 522-1 to 522-3 are close-up images and the other two model images displayed on the image display areas 522-4 and 522-5 are whole-body images. Among the image display areas 522-1 to 522-5, an image display area, on which the model image corresponding to the shooting to be performed next is displayed, is highlighted with a thick frame. In the example of FIG. 22, the image display area 522-1 is highlighted with the thick frame.

The users adjust the positions of their bodies to fit their faces and the upper half of the bodies inside the image display area 521, with reference to postures of the model image on the image display area highlighted with the thick frame among the image display areas 522-1 to 522-5 and checking the display of the image display area 521.

After the live view image is displayed for a predetermined time, a countdown to the shooting is started. Then, at the timing of the shooting, the shooting control section 323 performs the close-up shooting and obtains the still image as the close-up image. The display control section 321 displays a shooting result of the close-up shooting on the touch panel monitor 92.

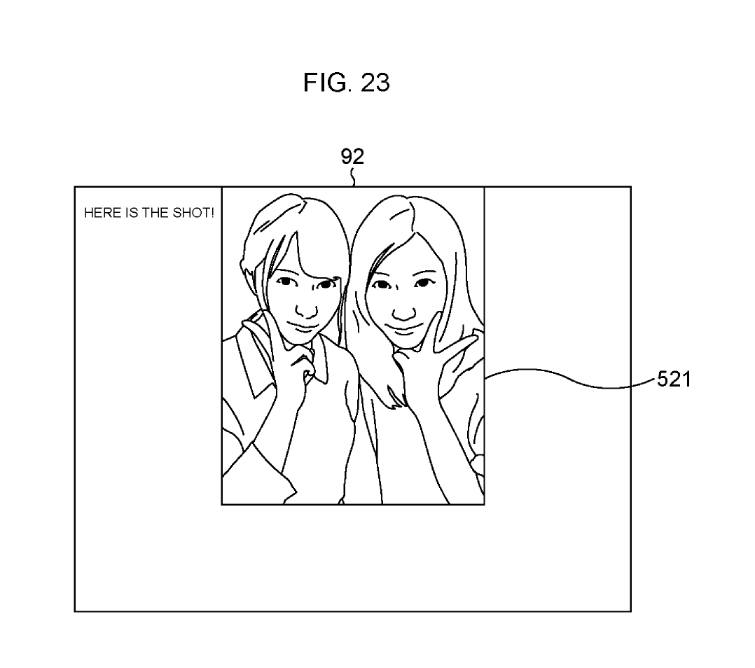

FIG. 23 is a diagram illustrating an example of a shooting result confirmation screen of the close-up shooting.

On the image display area 521 of the shooting result confirmation screen, the still image (close-up image) obtained by the close-up shooting is displayed. On the upper-left part of the shooting result confirmation screen, a message “Here is the shot!” is displayed.

As described above, the close-up shooting is performed three times.

Note that, on the live view display screen of FIG. 22, among the image display areas 522-1 to 522-5, on an image display area corresponding the shooting which has been performed, the still image obtained by the shooting is displayed.

When the close-up shooting is completed three-times, the guidance outputting control section 324 displays, on the touch panel monitor 92, a screen for explaining how to perform whole-body shooting to obtain a whole-body image. Then, in step S34, the shooting control section 323 performs the whole-body shooting.

Although detailed description is omitted, the whole-body shooting is similarly performed two times to the above described close-up shooting.

After step S34, the processing proceeds to step S35. In step S35, the guidance outputting control section 324 guides the users who have completed the shooting to the editing space A2-1 or the editing space A2-2. The guide to the editing space is performed by displaying a guide screen on the touch panel monitor 92 or by outputting sound from the speaker 233.

### (Shooting Processing of One-Person Course)

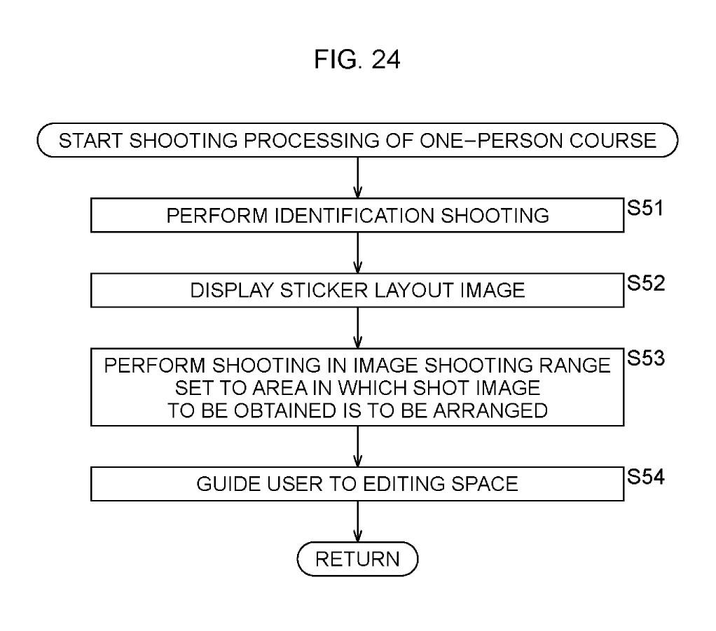

Next, shooting processing of the one-person course will be described with reference to the flowchart of FIG. 24.

When the shooting processing of the one-person course is started, the guidance outputting control section 324 displays a screen for explaining how to perform identification shooting on the touch panel monitor 92. Then, in step S51, the shooting control section 323 performs the identification shooting.

In the one-person course, the identification shooting is performed in order to identify the face organs (such as eyes and a mouth) of the user. An identification image obtained by the identification shooting is also neither edited in editing processing nor printed on a sticker sheet in printing processing. The identification image is used only to identify the face organs.

When the guidance is completed, the shooting control section 323 starts to capture the moving image by the camera 91. Then, the display control section 321 displays the moving image, in which the user appears, captured by the camera 91 on a live view display screen.

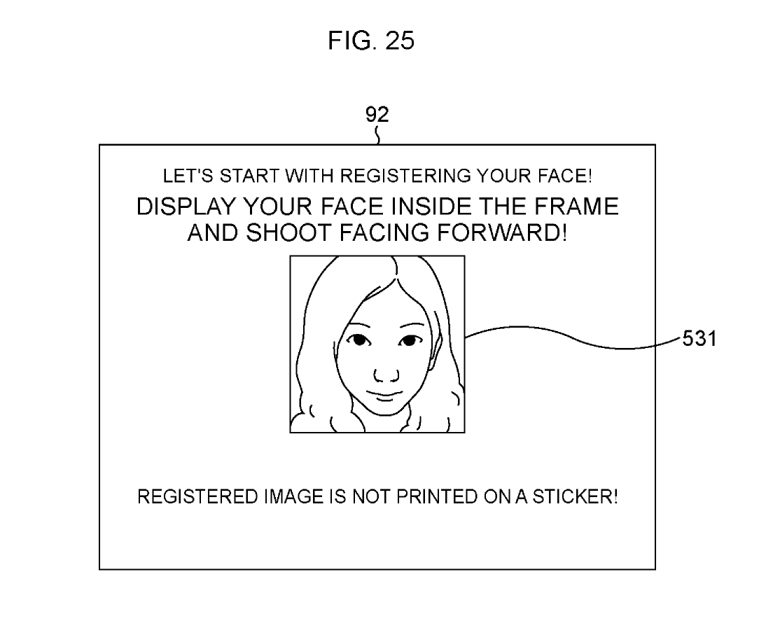

FIG. 25 is a diagram illustrating an example of the live view display screen of the identification shooting.

On the upper part of the live view display screen, a message “Let's start with registering your face! Display your face inside the frame and shoot facing forward!” is displayed.

On an image display area 531 provided under the message, the moving image in which the single user appears is displayed in real time. Under the image display area 531, a message “Registered image is not printed on a sticker!” is displayed.

A predetermined area of the moving image captured by the camera 91 is cut-out and displayed on the image display area 531. The single user adjusts the face position to fit the face inside the image display area 531 checking the display of the image display area 531.

After the live view image is displayed for a predetermined time, a countdown to the shooting is started. Then, at the timing of the shooting, the shooting control section 323 performs the identification shooting and obtains the still image as the identification image. The display control section 321 displays a shooting result of the identification shooting on the touch panel monitor 92.

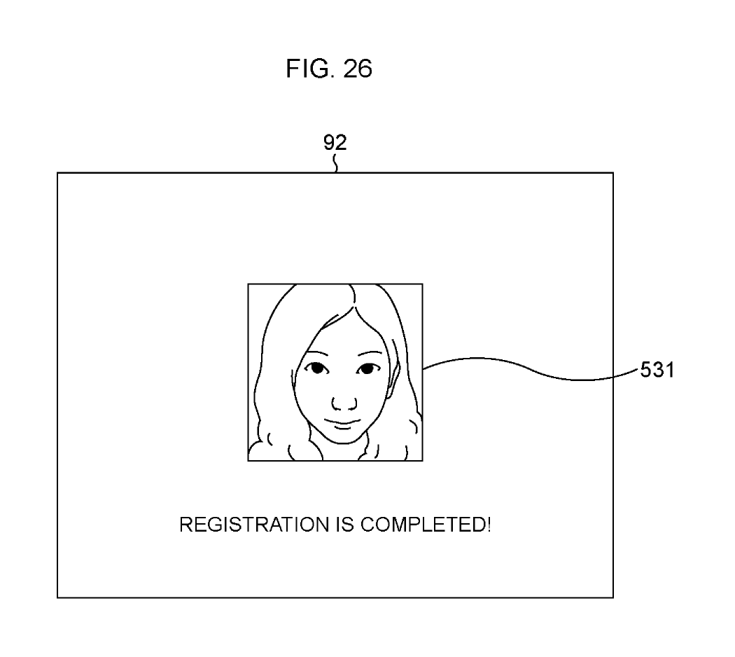

FIG. 26 is a diagram illustrating an example of a shooting result confirmation screen of the identification shooting.

On the image display area 531 of the shooting result confirmation screen, the still image (identification image) obtained by the identification shooting is displayed. Under the image display area 531, a message “Registration is completed!” is displayed.

As described above, the identification shooting is performed.

When the identification shooting is completed, the guidance outputting control section 324 displays a screen for explaining how to perform the shooting on the touch panel monitor 92. Then, in step S52, the display control section 321 displays, on the touch panel monitor 92, the sticker layout image selected in the pre-service processing.

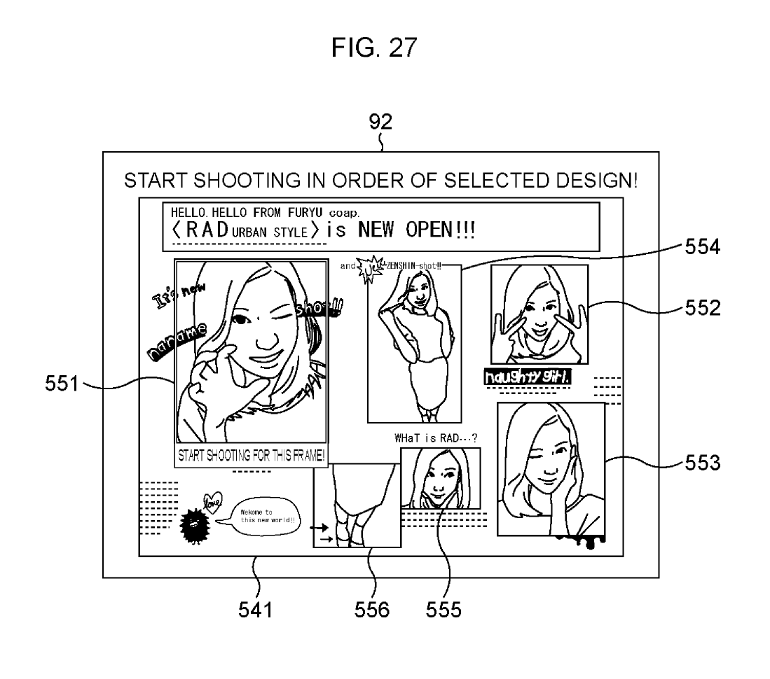

FIG. 27 is a diagram illustrating an example of a sticker layout image display screen.

On the upper part of the sticker layout image display screen, a message “Start shooting in order of selected design!” is displayed. Under the message, a sticker layout image 541 selected in the pre-service processing is displayed. Here, it is assumed that a sticker layout image 452 is selected on the sticker layout selection screen of FIG. 18.

In the sticker layout image 541, six shot image arrangement areas 551 to 556 are provided. On each of the shot image arrangement areas 551 to 556, a close-up image or a whole-body image is arranged as a model image. More specifically, close-up images are arranged on the shot image arrangement areas 551, 552, 553, and 555, and a whole-body image is arranged on the shot image arrangement area 554. Furthermore, on the shot image arrangement area 556, an image, in which the legs of the user appear, is arranged. It is assumed that the image, in which the legs of the user appear, is, for example, the image obtained by cutting-out (trimming) the part of the legs of the user from the whole-body image arranged on the shot image arrangement area 554.

Among the shot image arrangement areas 551 to 556, the shot image arrangement area, on which a model image corresponding to the shooting to be performed next is displayed, is highlighted with the thick frame and a message “Start shooting for this frame!”. In the example of FIG. 27, the shot image arrangement area 551 is highlighted.

After the highlighting is performed for a predetermined time, the processing proceeds to step S53. In step S53, the shooting control section 323 shoots the user in an image shooting range set to the area on which the shot image to be obtained is to be arranged (that is, the highlighted shot image arrangement area).

More specifically, the shooting control section 323 starts to capture the moving image by the camera 91. Then, the display control section 321 displays the moving image, in which the user appears, captured by the camera 91 on a live view display screen.

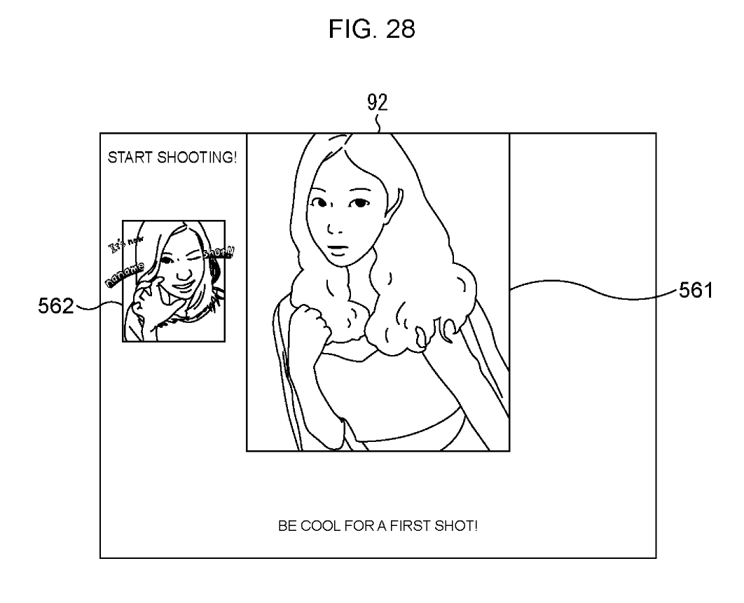

FIG. 28 is a diagram illustrating an example of the live view display screen.

On the upper-left part of the live view display screen, a message “Start shooting!” is displayed. On an image display area 561 provided in substantially the center of the live view display screen, the moving image, in which the single user appears, is displayed in real time. Furthermore, on the left part of the image display area 561, a model image display area 562 is provided. On the model image display area 562, the model image arranged on the highlighted shot image arrangement area 551 in the sticker layout image 541 is displayed. Since the model image arranged on the shot image arrangement area 551 is a close-up image, the image shooting range of the shooting to be performed next is the face and the upper half of the body of the user.

The user adjusts the position of the body to fit the face and the upper half of the body inside the image display area 561, with reference to a posture of the model image on the model image display area 562 and checking the image display area 561.

After the live view image is displayed for a predetermined time, a countdown to the shooting is started. Then, at the timing of the shooting, the shooting control section 323 performs the close-up shooting and obtains the still image as the close-up image. The display control section 321 displays a shooting result of the close-up shooting on the touch panel monitor 92.

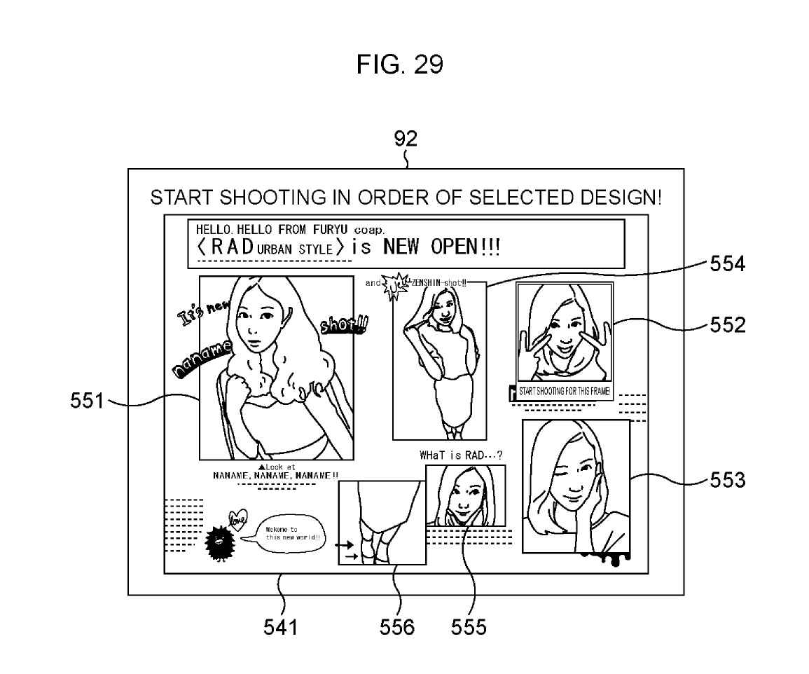

After the shooting is performed in the image shooting range set to the shot image arrangement area as described above, when further shooting is to be performed, the sticker layout image illustrated in FIG. 29 is displayed again.

In the sticker layout image of FIG. 29, on the shot image arrangement area 551, a shot image (close-up image) obtained by the shooting which has been performed is arranged. The shot image arrangement area 552, on which a model image corresponding to the shooting to be performed next is displayed, is highlighted.

Note that, in the sticker layout image of FIG. 29, after the shot image arrangement area 554, on which a whole-body image is displayed as a model image, is highlighted, the whole-body shooting which shoots the whole-body of the user is performed.

As described above, when the shooting is performed the number of times according to the number of shot image arrangement areas in the sticker layout image, the processing proceeds to step S54. In step S54, the guidance outputting control section 324 guides the user who has completed the shooting to the editing space A2-1 or the editing space A2-2. The guide to the editing space is performed by displaying a guide screen on the touch panel monitor 92 or by outputting sound from the speaker 233.

Note that, when a plurality of same shot image is arranged in the sticker layout image, the number of shooting is different from that of the shot image arrangement areas.

Furthermore, a sticker layout image which performs the shooting, for example, five times, six times, or seven times is prepared. In this case, a user who wants to perform the shooting many times can select the sticker layout image which performs the shooting seven times. On the other hand, a user who wants larger shot images printed on a sticker sheet at the end can select the sticker layout image which performs the shooting five times.

Naturally, since an impression of a user on each of the sticker layout images is different, a user can select a sticker layout image in terms of design.

With the processing, among the shot images arranged in the sticker layout image, the user can grasp that the shooting for a shot image to be arranged on which area is to be performed. Furthermore, the user can perform the shooting checking the live view of the image shooting range set to the area on which the shot image to be arranged. The user can thereby obtain a composite image, in which the shot image arranged and composited on the sticker layout image, printed on a sticker sheet at the end as the user imagined. In other words, it is possible to more reliably provide a sticker sheet as the user imagined.

Note that, a composite image, in which the shot image arranged and composited on the sticker layout image, printed on a sticker sheet may be transmitted to a mobile terminal of the user through the server.

In the above described shooting processing, when the two-persons course or the one-person course is selected, an identification image is obtained before a close-up image and a whole-body image, which are to be edited and to be printed on a sticker sheet, are obtained. However, the identification shooting to obtain the identification image may be performed at any time in the shooting processing.

In the above described shooting processing of the one-person course, although the number of shooting is determined according to the number of shot image arrangement areas in the sticker layout image, the number of shooting may be changed according to a pattern arranged in the sticker layout image or a hue of the sticker layout image.

Furthermore, when the pre-service portion 20 is not provided to the photo sticker creating device 1, by providing the pre-service processing section 301 to the shooting processing section 302, the pre-service processing and the shooting processing may be performed in the shooting space A1.

### <Details of Editing Processing>

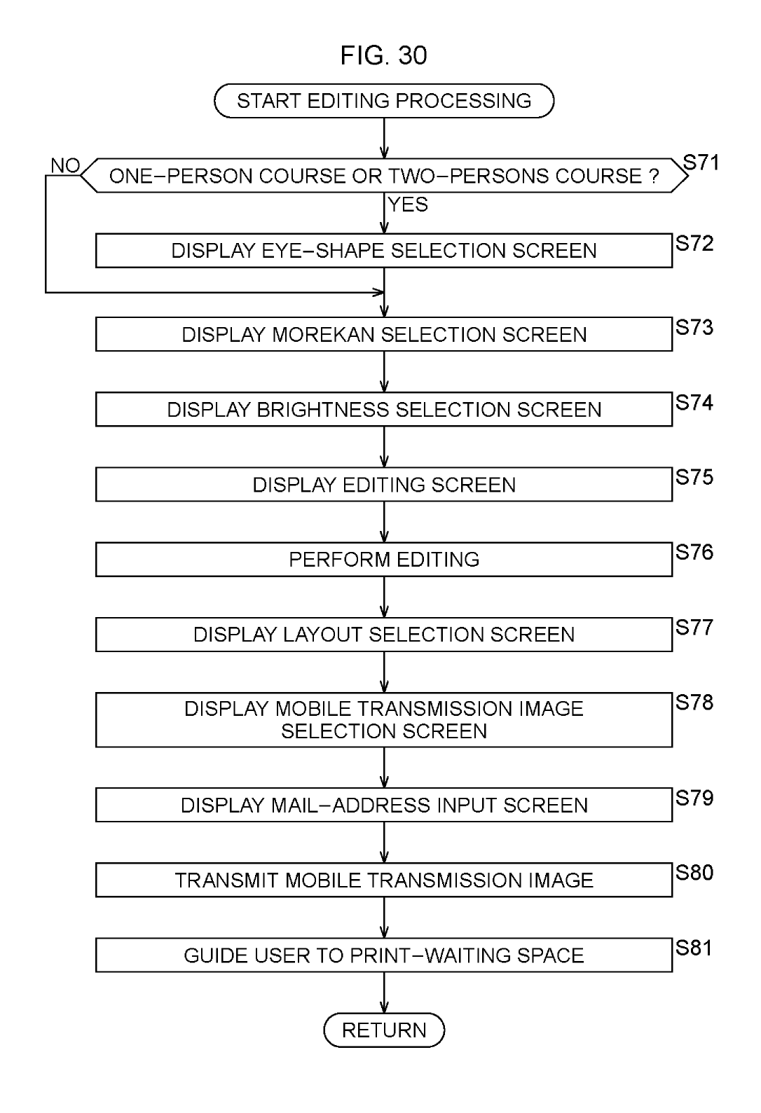

Next, details of editing processing in step S4 in the above described series of processing of the photo sticker creation game will be described with reference to the flowchart of FIG. 30. Note that, regardless of the person-number course selected in the pre-service processing, the similar editing processing is basically performed.

In step S71, the editing processing section 303 determines whether the person-number course is the one-person course or the two-persons course.

When the person-number course is the one-person course or the two-persons course, the guidance outputting control section 335 displays a screen for explaining how to select a shape of eyes on the tablet built-in monitor 131. Then, the processing proceeds to step S72, the display control section 331 displays an eye-shape selection screen on the tablet built-in monitor 131.

On the eye shape selection screen, a plurality of face images which have different shapes of eyes is displayed. These face images are generated by performing a plurality of types of image processing (eye-shape changing processing) to the area of the eyes of the user in the identification image obtained by the identification shooting in order to change the shapes of the eyes. Note that, the images displayed on the eye-shape selection screen are not only the face images but also eye images which have different shapes and includes at least an eye area to which the eye-shape changing processing is to be performed.

By each of the users, when any one of the face images displayed on the eye-shape selection screen is selected, the input receiving section 332 receives the selection. Then, the image processing section 333 performs the eye-shape changing processing performed to the selected face image to the respective shot images obtained by the shooting processing.

Note that, when the person-number course is the three-or-more-persons course, step S72 is skipped and the eye-shape selection screen is not displayed.

When the shape of eyes is selected or the editing processing of the three-or-more-persons course is started, the guidance outputting control section 335 displays a screen for explaining how to select “Morekan” on the tablet built-in monitor 131. Then, in step S73, the display control section 331 displays a Morekan selection screen on the tablet built-in monitor 131.

Note that, the “Morekan” indicates the degree of exaggeration to exaggerate (flatter) an impression of appearance, such as a size of eyes, a size of a face, and thickness of eyelashes.

On the Morekan selection screen, a plurality of face images having a different size of eyes, a different size of a face, and different thickness of eyelashes, is displayed. These face images are generated by performing a plurality types of image processing (Morekan changing processing) to the areas of the eyes and the face of the user in the identification image obtained by the identification shooting in order to change the size of eyes, the size of the face, and the thickness of the eyelashes.

When any one of the face images displayed on the Morekan selection screen is selected by the user, the input receiving section 332 receives the selection. Then, the image processing section 333 performs the Morekan changing processing performed to the selected face image to the respective shot images obtained by the shooting processing.

With the Morekan changing processing, various types of processing individually performed to the face and each of the face organs can be combined and collectively performed. Therefore, with the Morekan changing processing, compared with the case in which the various types of image processing individually performed to the face and each of the face organs is performed by selecting the image processing one by one by the user, it is possible to save the user's trouble for the selection and is also possible to shorten the working time.

When the Morekan is selected, the guidance outputting control section 335 displays a screen for explaining how to select brightness on the tablet built-in monitor 131. Then, in step S74, the display control section 331 displays a brightness selection screen on the tablet built-in monitor 131.

On the brightness selection screen, for example, a plurality of shot images obtained by the shooting processing, a plurality of brightness selection buttons, and a confirmation button are displayed. The brightness selection button is used to select the brightness of skin. The confirmation button is used to confirm the brightness selected by the brightness selection button.

When any one of the brightness selection buttons displayed on the brightness selection screen is selected by the user, the input receiving section 332 receives the selection. Then, the image processing section 333 detects the area of the skin of the person from the shot image and adjusts the brightness of the detected area according to the selected brightness selection button.

When the confirmation button is operated on the brightness selection screen, the guidance outputting control section 335 displays a screen for explaining how to proceed with the editing work on the tablet built-in monitor 131. Then, in step S75, the display control section 331 displays an editing screen on the tablet built-in monitor 131.

Although the detail will be described later, a different editing screen is displayed on the two-persons course and the three-or-more-persons course and on the one-person course.

In step S76, when the input receiving section 332 receives the editing work to the shot image displayed on the editing screen, the editing section 334 edits the shot image.

When the editing work is completed, in step S77, the display control section 331 displays a layout selection screen on the tablet built-in monitor 131. Then, the input receiving section 332 receives a selection of the number of divisions of a sticker sheet by the user.

Here, when the two-persons course or the three-or-more-persons course is selected, by selecting the number of divisions of a sticker sheet, the sticker layout (sticker layout image) and the number of divisions of the sticker sheet are determined. When the one-person course is selected, the number of divisions of the sticker sheet is simply selected.

Note that, information indicating the sticker layout is supplied to the printing processing section 304. Using the information, the printing processing section 304 prints, on a sticker sheet, the sticker layout images in which the shot images or the edited images arranged on the respective areas, divided into the number of divisions selected by the user, of the sticker sheet.

In step S78, the display control section 331 displays a mobile transmission image selection screen on the tablet built-in monitor 131. Then, the input receiving section 332 receives the user's instruction to select, for example, a shot image as a mobile transmission image. Here, not only the shot image but also the edited image may be selected as the mobile transmission image. Furthermore, the number of images to be selected as the mobile transmission images is not limited to one image and may be two or more images.

In step S79, the display control section 331 displays a mail-address input screen on the tablet built-in monitor 131. Then, the input receiving section 332 receives an input of a mail-address of a mobile terminal of the user.

Then, when a predetermined time has passed or a finish button is operated, the processing proceeds to step S80. In step S80, the communication control section 336 transmits the selected mobile transmission image and the mail-address input by the user to a server through a network, such as the Internet, by controlling the communication section 203. The server is administered by, for example, the manufacture of the photo sticker creating device 1.

The server sends, to the mail-address input by the user, a mail containing a necessary uniform resource locator (URL) for a mobile terminal to access. Then, when the mobile terminal of the user accesses the server through a network based on the URL, the mobile transmission image transmitted to the server is provided to the mobile terminal.

Thereafter, in step S81, the guidance outputting control section 335 guides the user who has completed the editing work to the print-waiting space A3. The guide to the print-waiting space A3 is performed by displaying a guide screen on the tablet built-in monitor 131 of the editing section 210 or by outputting sound from the speaker 241.

### <Examples of Editing Screen>

Here, an example of the editing screen displayed in step S75 of FIG. 30 will be described.

### (Editing Screen of the Two-Persons Course or the Three-or-More-Persons Course)

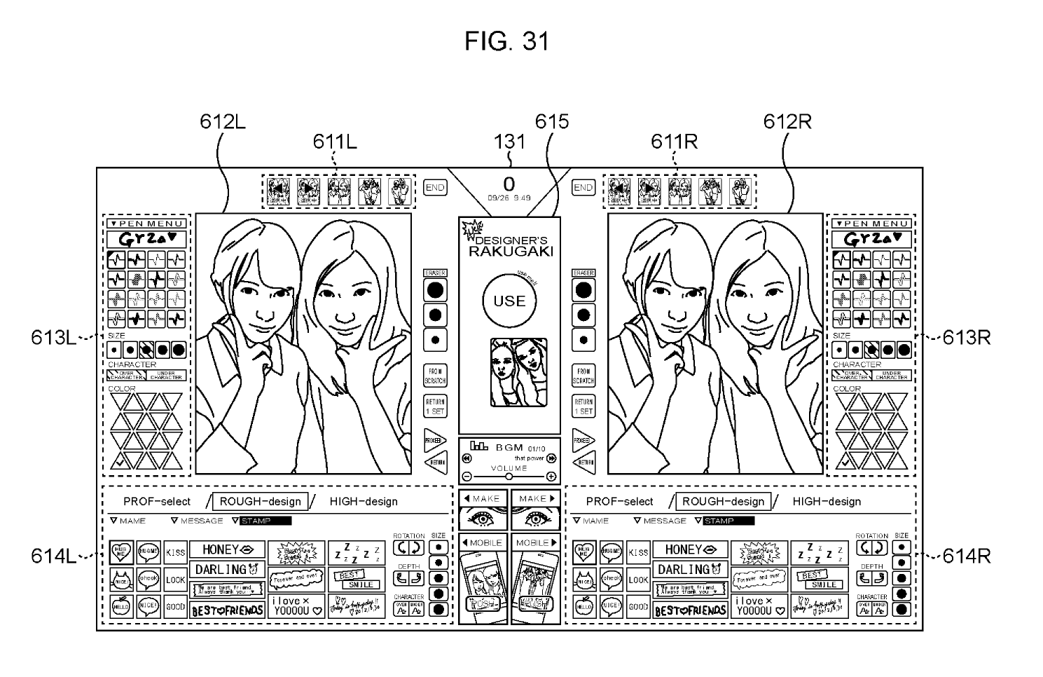

First, with reference to FIG. 31, an example of the editing screen of the two-persons course or the three-or-more-persons course will be described.

The editing screen of the two-persons course or the three-or-more-persons course is basically configured such that main configurations are symmetrically provided. A left-half area is used by the user on the left side facing the tablet built-in monitor 131. A right-half area is used by the user on the right side facing the tablet built-in monitor 131. On a central area, a remaining time of the editing processing and the like are displayed. Hereinafter, the left-half area of the editing screen will be mainly described.

On the upper-center part of the left-half area, a thumbnail image display area 611L is provided. The thumbnail image display area 611L is for displaying thumbnail images indicating the shot images. By selecting a thumbnail image displayed on the thumbnail image display area 611L, the user can select the shot image to be edited.

On substantially the center of the left-half area, an editing area 612L is provided. The editing area 612L is for displaying the shot image selected to edit. By selecting an editing tool (images for compositing, such as pen images and stamp images) with the stylus 132A, the user can perform the editing work to the shot image displayed on the editing area 612L.

On the left side of the editing area 612L, a pen palette display area 613L is provided. The pen palette display area 613L is for displaying a pen palette to select a pen image used for a handwriting input. On the pen palette display area 613L, a plurality of buttons to select a type of line, a thickness, and a color of the pen image is displayed. The pen palette of the pen palette display area 613L remains displayed while the editing screen is displayed.

On the lower side of the editing area 612L, an editing palette display area 614L is provided. The editing palette display area 614L is for displaying an editing palette to select various editing tools (images for compositing), such as stamp images and the like. The images for compositing displayed on the editing palette are categorized. By selecting a tab to which each of the category names is attached, the images for compositing displayed on the editing palette are switched.

On a central area of the editing screen, a one touch editing button 615 is provided. The one touch editing button 615 is operated when the one touch editing is performed. The one touch editing is a function to perform editing work of contents set in advance with a single operation. By operating the one touch editing button 615, images for compositing set in advance are collectively composited on the shot image. A user who is not accustomed to the editing work can thereby finish the editing work easily.

On the right-half area of the tablet built-in monitor 131, the same configuration as the above described left-half area is basically symmetrically arranged.

With the editing screen, two users can perform the editing work at the same time.

### (Editing Screen of the One-Person Course)

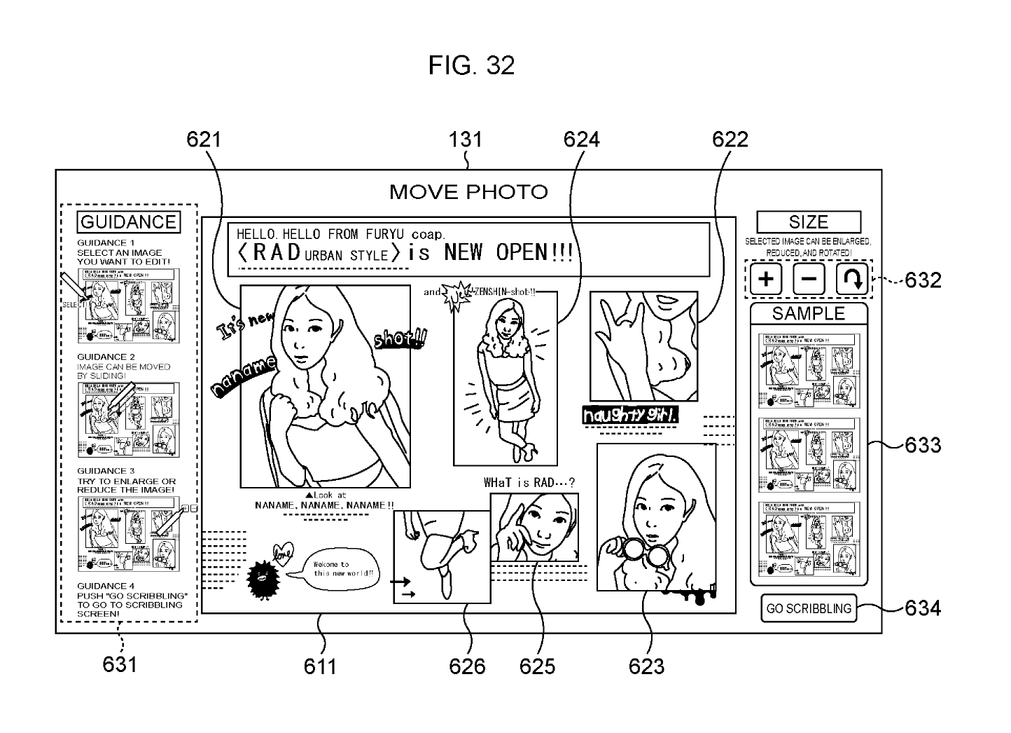

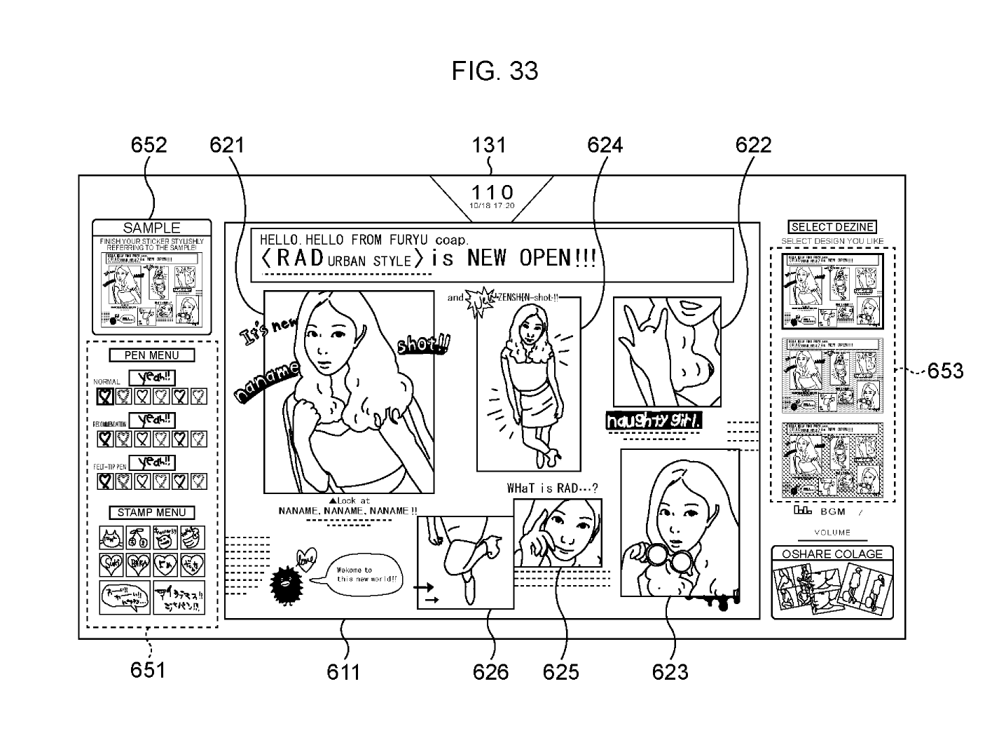

Next, with reference to FIGS. 32 and 33, an example of the editing screen of the one-person course will be described.

In the editing processing of the one-person course, first, a first editing screen illustrated in FIG. 32 is displayed as the editing screen.

On the center of the first editing screen, a sticker layout image 611 selected in the pre-service processing is displayed. On the sticker layout image 611, six shot images 621 to 626 obtained in the shooting processing are arranged and composited.

On the left part of the sticker layout image 611, a guidance display area 631 is provided. On the guidance display area 631, guidance for explaining the editing work which can be performed on the editing screen is displayed. More specifically, four explanations are given with sentences and images. The first explanation (guidance 1) shows that an editing target image can be selected from among the shot images 621 to 626 arranged in the sticker layout image 611. The second explanation (guidance 2) shows that the image selected to edit (editing target image) can be slid (moved) within the shot image arrangement area of the sticker layout image 611. The third explanation (guidance 3) shows that the editing target image can be enlarged or reduced within the shot image arrangement area of the sticker layout image 611. The fourth explanation (guidance 4) shows that a screen transition to a second editing screen (scribbling screen) can be performed.

On the right part of the sticker layout image 611, an enlargement/reduction/rotation button 632, a sample layout image display area 633, and a screen transition button 634 are provided.

The enlargement/reduction/rotation button 632 is for performing the enlargement, the reduction, and the rotation to the editing target image within the shot image arrangement area as described in the above guidance 3. The enlargement and reduction of the editing target image is limited in a predetermined range. Similarly, the rotation range of the editing target image is limited so as not to miss a part of the editing target image.

On the sample layout image display area 633, three sample layout images are displayed. The sample layout image is that the shot images 621 to 626, to which the edition shown on the guidance display area 631 is performed in advance, arranged and composited on the sticker layout image 611. The user can perform the editing work to the shot images 621 to 626 with reference to the sample layout images.

The screen transition button 634 is for performing a screen transition to the scribbling screen described in the above guidance 4. By operating the screen transition button 634, the second editing screen (scribbling screen) illustrated in FIG. 33 is displayed.

On the center of the second editing screen, the sticker layout image 611, on which the shot images 621 to 626 are arranged and composited, is displayed in the same way as FIG. 32.

On the left side of the sticker layout image 611, the pen/stamp palette display area 651 and the sample layout image display area 652 are provided.

On the pen/stamp palette display area 651, a pen palette and a stamp palette are displayed. The pen palette is for selecting the pen image used for the handwriting input. The stamp palette is for selecting the stamp image to be composited on the editing target image. A type of line, a thickness, and a color of the pen images displayed on the pen palette and a color, a pattern, and the like of the stamp images displayed on the stamp palette are suitable for the design of the sticker layout image 611.

Whereby, without impairing a sense of unity of the sticker layout image and the shot images arranged on the shot image arrangement area thereof, it is possible to provide a finished sticker sheet with a sense of unity at the end.

On the sample layout image display area 652, one sample layout image is displayed. The sample layout image is that the shot images 621 to 626, to which the edition using the pen image and the stamp image displayed on the pen/stamp palette display area 651 is performed in advance, are arranged and composited on the sticker layout image 611. The user can perform the editing work to the shot images 621 to 626 with reference to the sample layout image.

On the right part of the sticker layout image 611, a color layout image display area 653 is provided.

In the color layout image display area 653, three sticker layout images of the sticker layout image 611, to which different colors are added, are displayed. When any one of the three sticker layout images is selected, the color added to the selected sticker layout image is reflected in the sticker layout image 611. Note that, in addition to a color of a sticker layout image, a hue of the shot image arranged in the sticker layout image may be changed according to the color of the sticker layout image.

As described above, in the one-person course, the user can perform the editing work to the respective shot images, while the shot images are displaying in the sticker layout image. The user can thereby perform the editing work while imaging the finished entire image to be printed on a sticker sheet. That is, it is possible to more reliably provide a sticker sheet as the user imagined.

In the above description, the sticker layout image is selected before shooting in the one-person course. However, by reselecting a sticker layout image before printing (for example, in the editing processing), the sticker layout image may be changed.

As described above, in the one-person course and in the two-persons course or the three-or-more-persons course, the different games are provided to the user. Therefore, the user can enjoy different courses in the photo sticker machine of the same model and it is possible to further improve the satisfaction of the user.

Conventionally, a photo sticker machine having a button to switch an editing screen illustrated in FIG. 31 to perform the editing work to a shot image selected one by one to a screen illustrated in FIG. 33 to perform the editing work with displaying an entire sticker layout is known. However, some users have not noticed the button.

On the other hand, in the above described editing processing of the one-person course, the editing screen, on which the entire sticker layout is displayed, is displayed without a need to operate a button to switch the screen. Accordingly, the user can more reliably perform the editing work while grasping the entire sticker layout.

### <Modifications>

In the above description, the embodiments of the present technology have been descried, but modifications described below may be applicable.

### (Another Example of Sticker Layout Image)

In the above description, the example of a plurality of shot images to be arranged in the sticker layout image has been described. However, as described above, a single shot image may be arranged in the sticker layout image.

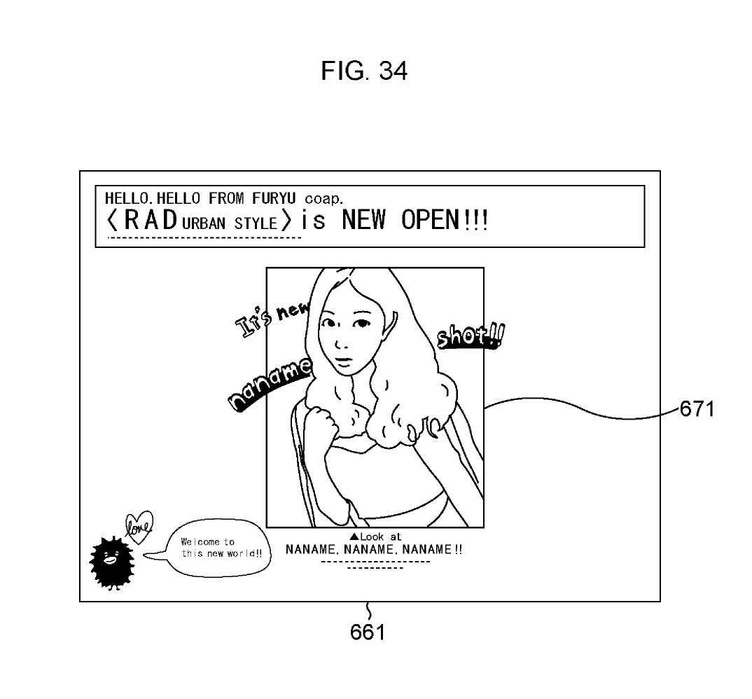

More specifically, a sticker layout image 661 illustrated in FIG. 34 is prepared. The sticker layout image 661 has a single shot image arrangement area. In the example of FIG. 34, on the shot image arrangement area, a single close-up image 671 is arranged. That is, the face and the upper-half of the body of the user is set to the shot image arrangement area of the sticker layout image 661 as the image shooting range. Therefore, for example, when the sticker layout image 661 is selected on the sticker layout selection screen, the close-up shooting is performed.

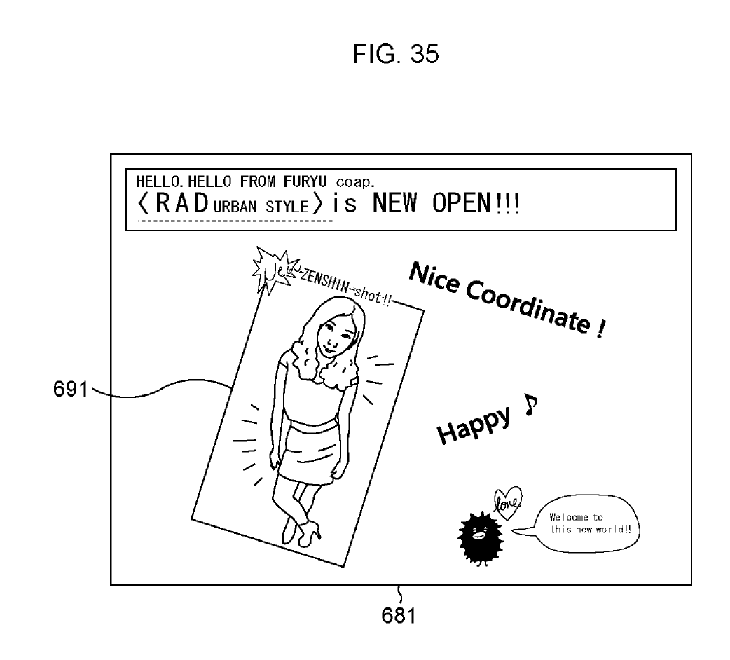

Furthermore, a sticker layout image 681 illustrated in FIG. 35 is prepared. The sticker layout image 681 has also a single shot image arrangement area. In the example of FIG. 35, on the shot image arrangement area, a single whole-body image 691 is arranged. That is, the whole-body of the user is set to the shot image arrangement area of the sticker layout image 681 as the image shooting range. Therefore, for example, when the sticker layout image 681 is selected on the sticker layout selection screen, the whole-body shooting is performed.

### (Determination of Person-Number Course)

In the above description, the determination of the person-number course is performed by selecting the button displayed on the person-number course selection screen. In addition, for example, after the pre-service processing is started, the uses are requested to input the names or the mail-addresses as the pre-service processing and by detecting the number of persons based on the input number of the names or the mail-addresses, the person-number course may be determined. Alternatively, by providing an easy game, such as a questionnaire or a fortune-telling, in which the respective users can participate, the person-number course may be determined based on the number of the participants.

Furthermore, a function to detect a fingerprint of a finger touching the touch panel monitor 71 is newly provided and by detecting the number of persons based on the number of the detected fingerprints, the person-number course may be determined. Alternatively, a camera or a human sensor is provided on the pre-service portion 20 and by detecting the number of persons, the person-number course may be determined.

Moreover, in the pre-service processing, an advertisement including, for example, a two-dimensional barcode to access a predetermined webpage from a mobile terminal of the user is displayed and by detecting the number of persons based on the number of the accesses, the person-number course may be determined. Similarly, in the pre-service processing, an operation to download a predetermined application to a mobile terminal of a user is performed by the user and, by detecting the number of persons based on the number of the downloaded applications, the person-number course may be determined.

### (Regarding Other Course Selection)

In the above description, when the person-number course is the one-person course, the processing of selecting a sticker layout image is performed before shooting. When other person-number course is selected, the processing of selecting a sticker layout image may be performed before shooting in the same way as the one-person course.

Furthermore, for example, a course regarding the shooting processing, such as a picture condition course to determine a picture condition of the object in the shot image or a course regarding editing processing is selected in the pre-service processing. Then, according to the selected course, the processing of selecting the sticker layout image before shooting may be performed.

Furthermore, in the pre-service processing, the user is requested to select the gender and by the selected gender, the processing of selecting the sticker layout image before shooting may be performed. For example, when the genders of two users are “female” and “female”, and “female” and “male”, the processing of selecting the sticker layout image before shooting may be performed when the users are and “female” and “male”. Furthermore, when the user is one person and “female”, the processing of selecting the sticker layout image before shooting may be performed.

Moreover, in the pre-service processing, the user is requested to input the age and based on the input age, the processing of selecting the sticker layout image before shooting may be performed.

Alternatively, the user may select whether the processing of selecting the sticker layout image before shooting is performed or not. For example, as a timing to select the sticker layout image, the user selects “before shooting” or “after shooting”. When “before shooting” is selected, the similar processing to the above described one-person course is performed. On the other hand, when “after shooting” is selected, the similar processing to the above two-persons course and three-or-more-persons course is performed.

### (Designs of Sticker Layout Image)

As the sticker layout image selected on the sticker layout selection screen, the sticker layout image adorned with the design relating to a theme according to the seasons may be prepared. For example, in December, the sticker layout image designed for a Christmas is displayed on the sticker layout selection screen. Furthermore, in January, the sticker layout image designed for a new year is displayed on the sticker layout selection screen. The user can thereby perform the shooting in a mood for a seasonal event and can be highly satisfied.

In this case, the shot image arrangement area of the sticker layout image includes a stamp image with a theme according to the seasons. Then, the shooting may be performed while the stamp image is composited (displayed) on the live view display screen. For example, the sticker layout image designed for a Christmas is selected. In this case, the shooting for any one of the shot images arranged in the shot image arrangement areas of the sticker layout image is performed, while a stamp image representing a Christmas tree is composited on the live view display screen. The user can thereby perform the shooting with a posture matched with the Christmas tree and obtain the finished image with interest.

### (Images Transmitted to Mobile Terminal)

As described above, the shot image and the edited image selected by the user and the composite image in which the shot image is arranged in the sticker layout image are transmitted to the mobile terminal of the user through the server. In this case, the server may transmit the enlarged size of the image for transmission (mobile transmission image) to the mobile terminal of the user. The mobile transmission image displayed on the mobile terminal can be thereby suitable size for the display screen of the mobile terminal.

Furthermore, in the above described embodiments, the photo sticker creating device 1 can provide the mobile terminal of the user with the obtained shot image and edited image by transmitting the images to the server in addition to printing the images on the sticker sheet. However, a method for providing the images is not limited to this and the photo sticker creating device 1 may provide the mobile terminal of the user with the shot image and the edited image by transmitting the images to the server without printing the images on the sticker sheet. Conversely, the photo sticker creating device 1 may print the shot image and the edited image on the sticker sheet without transmitting the images to the server.

The above described series of processing may be executed by hardware or software. When the series of processing is executed by software, a program which configures the software is installed from a network or a recording medium.

The recording medium is configured separately from the main body of the device as illustrated in FIG. 9. The recording medium is configured with the removable media 205 implemented by, for example, a magnetic disk (including a flexible disk), an optical disk (including a compact disk read-only memory (CD-ROM) and a digital versatile disk (DVD)), a magneto-optical disk, or a semiconductor memory. The removable media 205 contains a program and is distributed to an administrator of the photo sticker creating device 1 to deliver the program. In addition, the recording medium is configured with the ROM 206 or a hard disk of the storage section 202 which contains the program distributed to the administrator and is equipped with the main body of the device in advance.

Note that, in the present specification, the steps describing the program recorded in the recording medium include not only the processing performed along the described order in time series, but also the processing executed in parallel or separately executed, even if not necessarily processed in time series.

In the above, a print medium is not limited to a sticker sheet or a photograph sheet. For example, an image may be printed on a sheet or a film having a predetermined size, a card, such as a pre-paid card or an integrated circuit (IC) card, or cloth such as a T-shirt, or the like. In this case, a sticker layout image, in which a single shot image or a plurality of shot images is arranged, may be printed on such print medium.

Furthermore, embodiments of the present technology are not limited to the above-described embodiments, and various changes can be made without departing from the gist of the present technology.

What is claimed is:

1. An image providing device comprising:
a first display control section configured to control display of a selection screen to receive a selection of a layout image;
a second display control section configured to control display of the selected layout image; and
a shooting section configured to shoot a user and generate one or more shot images, wherein
the layout image is an image in which the one or more shot images are arranged,
the second display control section displays, in the layout image, one or more areas on which the one or more shot images are arranged, and
the shooting section shoots the user in an image shooting range set to each of the one or more areas displayed in the layout image.

2. The image providing device according to claim 1, wherein
when shooting, the second display control section highlights one of the one or more areas on which one of the one or more shot images to be generated by the shooting section is to be arranged, and
the shooting section shoots the user in the image shooting range set to the highlighted area.

3. The image providing device according to claim 2, wherein the second display control section displays and arranges the one of the one or more shot images generated by the shooting section on the highlighted area.

4. The image providing device according to claim 1, wherein the shooting section shoots the user in the image shooting range, in which a predetermined part of the body of the user is shot, set to each of the one or more areas displayed in the layout image.

5. The image providing device according to claim 4, wherein the predetermined part of the body of the user is the face and the upper-half body of the user.

6. The image providing device according to claim 4, wherein the predetermined part of the body of the user is the whole-body of the user.

7. The image providing device according to claim 1, wherein the first display control section categorizes the layout images according to the image shooting range set to each of the one or more areas and displays the categorized layout image on the selection screen.

8. The image providing device according to claim 1, wherein on one of the one or more areas of the layout image, a predetermined part of an image cut-out from the one or more shot images to be arranged on another one of the one or more areas is to be arranged.

9. The image providing device according to claim 1, wherein the shooting section shoots the user the number of times according to the number of the one or more shot images arranged in the layout image.

10. The image providing device according to claim 9, wherein the second display control section controls display of the layout image each time the shooting section shoots the user, when the shooting is performed a plurality of times.

11. The image providing device according to claim 1, further comprising:
a third display control section configured to control display of an editing screen on which the layout image in which the one or more shot images are arranged is to be displayed; and
an editing section configured to edit, according to an input by the user, the one or more shot images arranged in the layout image displayed on the editing screen.

12. The image providing device according to claim 11, wherein the editing section changes at least a color of the layout image according to an input by the user.

13. The image providing device according to claim 1, further comprising a printing section configured to print the layout image in which the one or more shot images are arranged on each of the one or more areas, divided into the number of divisions selected by the user, of the sticker sheet.

14. The image providing device according to claim 1, further comprising a transmission section configured to transmit the layout image, in which the one or more shot images are arranged, to a mobile terminal of the user through a predetermined server.

15. The image providing device according to claim 1, wherein the first display control section controls display of the selection screen, when the number of the user is a predetermined number of persons.

16. An image providing method of an image providing device, the image providing device including
a first display control section configured to control display of a selection screen to receive a selection of a layout image,
a second display control section configured to control display of the selected layout image, and
a shooting section configured to shoot a user and generate one or more shot images,
the layout image being an image in which the one or more shot images are arranged,
the image providing method comprising:
displaying, in the layout image, one or more areas on which the one or more shot images are to be arranged by the second display control section; and
shooting the user in an image shooting range set to each of the one or more areas displayed in the layout image by the shooting section.
